(19) United States
(12) Patent Application Publication
(10) Pub. No.: US 2009/0059937 A1
(43) Pub. Date: Mar. 5, 2009

(54) Network system for guarantee QoS

(75) Inventor: Yasusi Kanada, Tokyo (JP)

Correspondence Address: Stanley P. Fisher;Reed Smith LLP, Suite 1400, Fairview Park Drive, Falls Church, VA, 22042-4503, US

(73) Assignee: Hitachi, Ltd.

(21) Appl. No.: 12/222,283

(22) Filed: Aug. 6, 2008

(30) Foreign Application Priority Data
Aug. 27, 2007 (JP) 2007-219951

(51) Int. Cl. H04L 12/26; H04L 12/56

(52) U.S. Cl. 370/401; 370/230; 370/235; 709/224

(57) ABSTRACT

Provided is a network system which is coupled to first and second computers including: at least one network node; a network device; and a resource management server. In the network system, QoS requirements are set for a communication between the first and second computers; the second computer measures QoS of the first communication, and transmits the control information including an identifier of the first communication and a result of the measurement of QoS to the first computer; the network device captures the control information, and transmits to the resource management server a message including the identifier of the first communication and the measurement result which are extracted from the captured control information; and the resource management server estimates a cause of failure in satisfying the QoS requirements if the measurement result does not satisfy the QoS requirements, and sets QoS for the network node judged to involve the cause.

### CLAIM OF PRIORITY

The present application claims priority from Japanese patent applications JP 2007-219951 filed on Aug. 27, 2007, the content of which is hereby incorporated by reference into this application.

### BACKGROUND OF THE INVENTION

This invention relates to a network system for forwarding a packet, and more particularly, to a technology of guaranteeing QoS in a network.

Up to now, in a network system such as the Internet, it has been difficult to guarantee communication quality in terms of end-to-end QoS such as delay and jitter between terminals and between a server and a terminal. However, Next Generation Networks (NGN) being standardized by ITU-T and ETSI aims at guaranteeing the end-to-end QoS in a new network based on Internet protocols.

If network services are standardized as in the conventional telephone network, necessary QoS requirements are held in advance by a network. However, in various multimedia communications considered to be widely used for the NGN, a terminal or a home gateway holds QoS requirements being necessary for the user to use a carrier's network (NGN) to perform multimedia communications and the like. However, the network of the carrier does not have the necessary QoS requirements. Therefore, the QoS requirements to be guaranteed between endpoint nodes may be requested from the network by devices provided at those nodes, and based on the request, a network resource management server (Resource Admission Control Functions (RACF) according to the terminology of the NGN) may decide a policy to control network resources such as a router.

Examples of a protocol to be used for conveying the QoS requirements in terms of a bandwidth used in the network, a permissible delay and jitter, and the like include Session Initiation Protocol (SIP) and Resource ReserVation Protocol (RSVP) which are protocols standardized by Internet Engineering Task Force (IETF) in the NGN standards. In addition, NSIS Signaling Layer Protocol (NSLP; where NSIS is a working group of the IETF) is being discussed for standardization by the IETF as a protocol used for more different kinds of purposes than the RSVP.

Even if the protocols such as SIP, RSVP, and NSLP are used to convey the QoS requirements to the network, values of delay, jitter, and the like cannot be directly controlled in the network. In the network, the resource management server decides only which resources (such as queue and output bandwidth) of the router are allowed to use for the communication traffic. Therefore, the specified QoS requirements may not be complied with by a method prepared in advance depending on how the network is crowded or other properties of traffic.

In such a case, a method such as a traffic measurement is used to check whether or not the specified conditions are satisfied, and if not satisfied, feedback can be provided. With regard to control of a network or a system, which uses the feedback, the following conventional technologies are available.

Disclosed in Colin Perkins, “RTP—Audio and Video for the Internet”, Addison-Wesley Pub, June 2003, is a method of improving the end-to-end QoS by using Real-time Transport Protocol (RTP) and Real-Time Control Protocol (RTCP) that are IETF standard protocols. In other words, in real-time communications, a receiving-end application measures the delay, the jitter, and the like, and conveys results thereof to a sender via the RTCP. However, this method cannot solve a problem occurring in the network.

Disclosed in JP 2005-354280 A is a method of collecting an application history and the like of a policy within a data center and optimizing the policy based on the collected information in order to optimize the network operation management policy in the data center. According to the method disclosed in JP 2005-354280 A, it is possible to improve the QoS by eliminating an inhibition factor within the data center. However, with the method disclosed in JP 2005-354280 A, QoS requirements on a terminal side cannot be held, which cannot guarantee the end-to-end QoS in terms of delay, jitter, and the like.

Disclosed in JP 2002-016599 A is a method of providing a measurement device in a network and causing the control server to control (distribute a policy across) the network based on measurement results. Even with the method disclosed in JP 2002-016599 A, similar to the method disclosed in JP 2005-354280 A, the QoS requirements on the terminal side cannot be held, which cannot guarantee the end-to-end QoS.

Disclosed in JP 2004-320159 A is a method of managing a QoS control module provided to a terminal by means of a “central controller” and a “central database”. According to the method disclosed in JP 2004-320159 A, it is possible to control the terminal depending on how the network is crowded, and to adapt the terminal to the network. However, with the method disclosed in JP 2004-320159 A, similar to the method described in Colin Perkins, “RTP—Audio and Video for the Internet”, Addison-Wesley Pub, June 2003, there exists no mechanism for controlling the network, and thus the QoS in the network cannot be controlled.

This invention has an object to enable feedback of end-to-end QoS requirements with respect to a network policy, which cannot be realized by the above-mentioned conventional technologies. Another object of this invention is to provide a method of allowing specified QoS requirements to be satisfied no matter which state a network is placed in or even when there is a change in the state of the network.

### SUMMARY OF THE INVENTION

The representative aspects of this invention are as follows. That is, there is provided a network system, which is coupled to a first computer having a communication interface and a second computer having a communication interface including: at least one network node provided on a communication path between the first computer and the second computer, for forwarding a packet between the first computer and the second computer; a network device for forwarding control information transmitted from the second computer to the first computer, and capturing the control information; and a resource management server for controlling the network node. In the network system, QoS requirements are set for a communication between the first computer and the second computer; the first computer periodically transmits a packet to the second computer to perform a first communication; the second computer measures QoS of the first communication, and transmits the control information including an identifier of the first communication and a result of the measurement of QoS to the first computer via the network device; the network device captures the control information, and transmits to the resource management server a message including the identifier of the first communication and the measurement result which are extracted from the captured control information; and the resource management server estimates a cause of failure in satisfying the QoS requirements if the measurement result does not satisfy the QoS requirements, and sets QoS for the network node judged to involve the cause.

According to an embodiment of this invention, it is possible to guarantee the end-to-end QoS requested by a terminal, a server, a gateway, and the like under more different kinds of network conditions. Further, it is possible to cause a network and endpoint nodes to cooperate with one another, to thereby guarantee the QoS at lower cost than the QoS is guaranteed only by the network.

### BRIEF DESCRIPTION OF THE DRAWINGS

The present invention can be appreciated by the description which follows in conjunction with the following figures, wherein:

FIG. 1 is a block diagram showing a configuration of a network system in accordance with first to third embodiments of this invention;

FIG. 2A is an explanatory diagram showing a format of an RTCP message containing an SNSLP message in accordance with first to fourth embodiments of this invention;

FIG. 2B is an explanatory diagram showing contents of the message body with the message type being “RES” in accordance with the first to fourth embodiments of this invention;

FIG. 2C is an explanatory diagram showing contents of a QoS request specifications in accordance with the first to fourth embodiments of this invention;

FIG. 2D is an explanatory diagram showing contents of the message body with the message type being “REP” in accordance with the first to fourth embodiments of this invention;

FIG. 3A is an explanatory diagram showing a format of an RRQ type message in accordance with the first to fourth embodiments of this invention;

FIG. 3B is an explanatory diagram showing a format of a TRQ type message in accordance with the first to fourth embodiments of this invention;

FIG. 3C is an explanatory diagram showing a format of an RPT type message in accordance with the first to fourth embodiments of this invention;

FIG. 3D is an explanatory diagram showing a first format of a DEC type message in accordance with the first to fourth embodiments of this invention;

FIG. 3E is an explanatory diagram showing a second format of a DEC type message in accordance with the first to fourth embodiments of this invention;

FIG. 4A is a diagram showing a sequence of a resource request phase in accordance with the first to third embodiments of this invention;

FIG. 4B is a diagram showing a sequence of a resource release phase in accordance with the first to third embodiments of this invention;

FIG. 4C is a diagram showing a sequence of a feedback phase in accordance with the first and second embodiments of this invention;

FIG. 4D is a sequence diagram showing a sequence of a feedback phase in accordance with the third embodiment of this invention;

FIG. 5 is a flowchart of a processing of deciding a policy for an entrance border router in accordance with the first to fourth embodiments of this invention;

FIG. 6 is a flowchart of a processing of deciding a policy for core routers in accordance with the first to fourth embodiments of this invention;

FIG. 7 is a block diagram showing a router function expansion device in accordance with the first to third embodiments of this invention;

FIG. 8 is a flowchart showing a processing executed by a router function expansion program in accordance with the first to third embodiments of this invention;

FIG. 9 is a flowchart of a processing of revising a policy by a policy server at a feedback time in accordance with the first to fourth embodiments of this invention;

FIG. 10 is a flowchart of a processing of updating an edge policy in accordance with the first embodiment of this invention;

FIG. 11 is a flowchart of a processing of updating a core policy in accordance with the first to fourth embodiments of this invention;

FIG. 12A is a block diagram showing a configuration of an access network in accordance with the second embodiment of this invention;

FIG. 12B is a block diagram showing a configuration of an access network in accordance with the second embodiment of this invention;

FIG. 13 is a block diagram showing a structure of a network system in accordance with the fourth embodiment of this invention;

FIG. 14A is a diagram showing a sequence of a resource request phase in accordance with the fourth embodiment of this invention;

FIG. 14B is a diagram showing a sequence of a resource release phase in accordance with the fourth embodiment of this invention; and

FIG. 14C is a diagram showing a sequence of a feed feedback phase in accordance with the fourth embodiment of this invention.

### DETAILED DESCRIPTION OF THE PREFERRED EMBODIMENTS

First, a description will be made of an outline of this invention.

In embodiments of this invention, provided as first means is an application program stored on a terminal and/or a server, for measuring, upon reception of traffic subjected to the QoS guarantee, QoS requirements for delay, jitter, packet loss, and/or the like that are related to the received traffic, setting measurement results into a report packet, and sending the report packet to a sender. It should be noted that a gateway functioning in a similar manner, which is provided between the terminal and/or the server and a network, may be used. In addition, provided as second means is a router for capturing contents of the above-mentioned report packet and reporting the contents to a resource management server. It should be noted that the router may be combined with a router function expansion device. In addition, provided as third means is a resource management server for changing a policy and a network setting based on the above-mentioned report.

By those means, the results from the measurement performed by the application program or gateway at a receiving end are transmitted to the application program or gateway at a transmitting end during communication. The router or the router function expansion device captures the transmitted measurement results, and conveys the captured contents to the resource management server. The resource management server can modify a network policy to satisfy the QoS requirements.

In short, by configuring a QoS guarantee mechanism in a network and a feedback loop containing two endpoint nodes, the two endpoint nodes can cooperatively guarantee the QoS.

In other words, no matter which state the network is placed in or even when there is a change in the state of the network, the network policy can be adjusted based on the results of measuring the end-to-end QoS, thereby making it possible to guarantee the end-to-end QoS requested by the terminal, the server, the gateway, and the like under different kinds of network conditions. Further, it is possible to cause devices provided at the endpoint nodes and the network to cooperate with one another, to thereby guarantee the QoS at lower cost than the QoS is guaranteed only by the network.

### First Embodiment

A description will be made of a first embodiment of this invention.

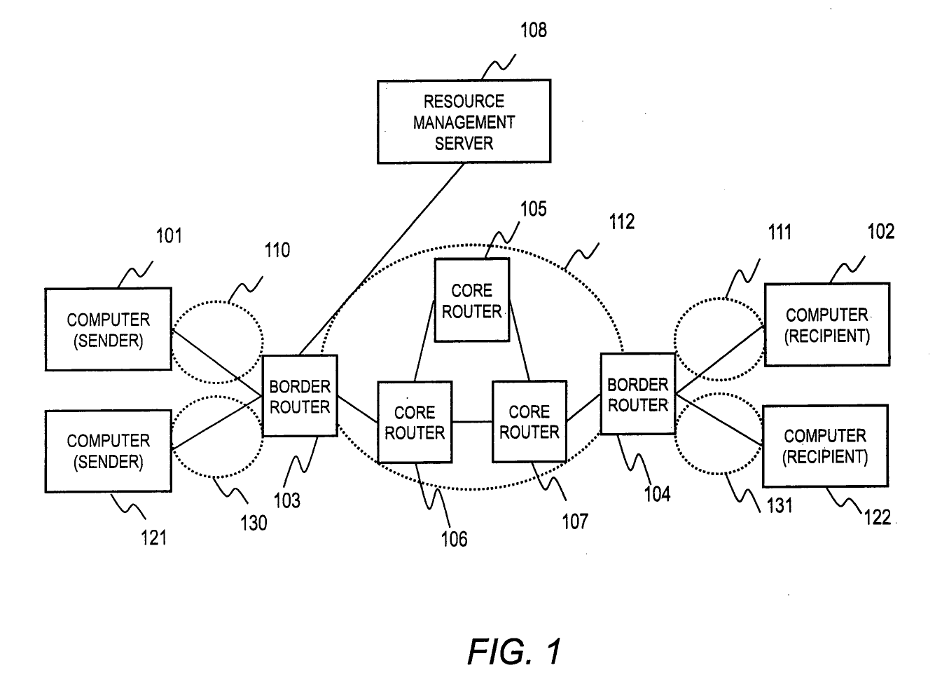

FIG. 1 is a block diagram showing a configuration of a network system according to the first embodiment.

In this embodiment, voice and/or images are transmitted from a computer 101 to a computer 102. Traffic generated on the computer 101 passes through an access network 110, and enters a carrier's core network 112 from a border router 103. The network 112 includes the border router 103, a border router 104, and core routers 105, 106, and 107.

The traffic that has entered the network 112 passes through the core routers 106 and 107, and is output from the border router 104 to leave the network 112. The traffic that has left the network 112 passes through an access network 111, and reaches the computer 102. QoS of the network 112 is managed by a resource management server 108.

In a similar manner, voice and/or images are transmitted from a computer 121 to a computer 122. Traffic generated on the computer 121 passes through an access network 130, and enters the carrier's network 112 from the border router 103. The traffic that has entered the network 112 passes through the core routers 106 and 107, and is output from the border router 104 to leave the network 112. The traffic that has left the network 112 passes through an access network 131, and reaches the computer 122.

The computers 101 and 102 and the resource management server 108 each include a central processing unit (CPU), a short-term storage unit (for example, memory), a long-term storage unit (for example, magnetic disk drive), and a communication unit (for example, network interface card). The central processing unit operates based on data input from the short-term storage unit, the long-term storage unit, and the communication unit, and outputs computation results to the short-term storage unit, the long-term storage unit, and the communication unit.

The border routers 103 and 104 and the core routers 106 and 107 each include a control unit, a plurality of communication units, a routing unit, and a switch unit. Each of the routers outputs, based on information held by the routing unit, a packet input from a first communication unit to a second communication unit or the first communication unit via the switch unit controlled by the control unit.

In this embodiment, the QoS of the network 112 is controlled by a Differentiated Services (Diffserv) system standardized by the IETF. According to Diffserv, an IP packet is assigned to a class at an entrance to or before a core network (network 112 of FIG. 1). In other words, the IP packet has a DSCP field in which a value corresponding to each different class is written (i.e., subjected to marking). The core routers 106 and 107 each perform QoS control corresponding to each different class based on the value of the DSCP field. In this embodiment, the border router 103 performs the marking, and based on the value of the marked DSCP field, the core routers 106 and 107 each select an output queue.

The Diffserv system controls how each router is to forward traffic according to the following classifications.

Expedited Forwarding (EF): Control for a service for which a specified QoS condition is to be guaranteed. EF traffic is given a higher priority than other traffic, and is handled by a priority queue.

Assured Forwarding (AF): Four classes of forwarding control (AF1, AF2, AF3, and AF4) varying in QoS condition can be defined. In general, a band is split into four according to those classes, and a packet discard rate used at occurrence of router congestion or other such occasion is varied among those classes.

Default Forwarding (DF): DF traffic is handled as best-effort. In other words, the QoS control is not performed.

In the core routers 106 and 107, four queues are provided to each output interface, and in this embodiment, are used as follows.

First queue: A higher-priority queue for voice traffic whose QoS request specifications are specified as a conversational class. The forwarding control for EF is performed.

Second queue: A weighted fair queue (WFQ) for image traffic whose QoS request specifications are specified as the conversational class and traffic whose QoS request specifications are specified as an interactive class. The forwarding control for AF is performed. In other words, a value “w2” is determined so that a necessary bandwidth is secured.

Third queue: A WFQ for image traffic whose QoS request specifications are specified as a streaming class. The forwarding control for AF is performed. In other words, a value “w3” is determined so that a necessary bandwidth is secured.

Fourth queue: A WFQ for traffic of a type other than the above-mentioned types (best-effort traffic). The forwarding control for DF is performed. A value “w4” is set as a value other than “0” (for example, 1%) so that a minimum bandwidth is secured. Used is an excess band that is not used by the other classes.

A packet stored in the first queue is subjected to scheduling more preferentially than packets stored in the other queues. The second to fourth queues are subjected to scheduling when there exists no packet in the first queue. However, an output bandwidth for the second to fourth queues split into w2, w3, and w4 (w2+w3+w4=1). The values w2, w3, and w4 are set by inputting a command into the core router. For example, a router that allows use of one priority queue and three WFQs is commercially available. Such a router has a function of splitting a band as described above. Such queue settings may be previously stored in the core router as default settings, or may be stored into the core router as default settings by the resource management server 108 during bootup of the resource management server 108.

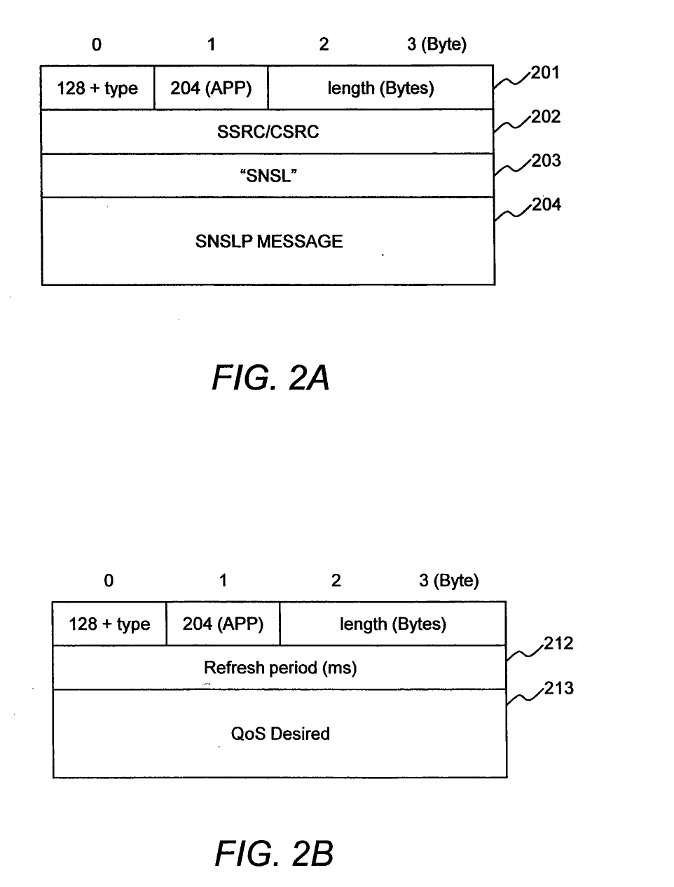

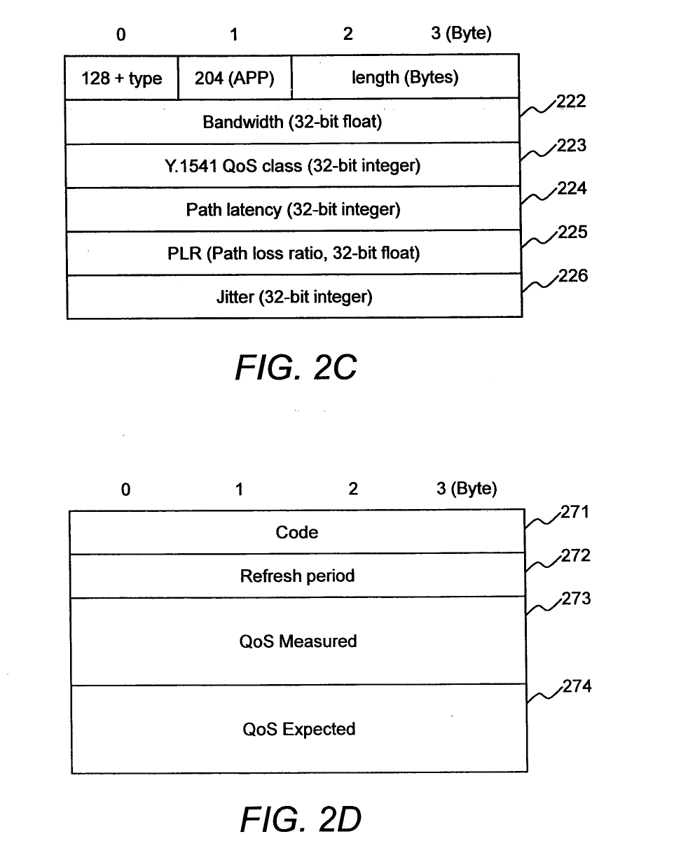

FIGS. 2A to 2D show data formats of a protocol for a resource request used in the first embodiment of this invention.

As the protocol for a resource request, Resource ReSerVation Protocol (RSVP) has already been standardized by the IETF. In addition, QoS NSIS Signaling Layer Protocol (NSLP) is being standardized by a Next-Step In Signaling (NSIS) working group. For the QoS control, those protocols may be used, but in this embodiment, a non-standard protocol, which is easier to implement, is used.

The protocol for a resource request according to this invention (hereinafter, referred to as “SNSLP”) is implemented on Real-Time Control Protocol (RTCP), which is an IETF-standard protocol. RTCP is a control-purpose protocol used in combination with Real-time Transport Protocol (RTP), which is an IETF-standard protocol for transmitting voice, video, and the like, and is implemented on User Datagram Protocol (UDP), which is an IETF-standard protocol similar to RTP. SNSLP is not necessarily implemented on RTCP, and may be implemented on UDP or TCP. It should be noted that the implementation on RTCP can simplify contents of a message.

SNSLP is a soft-state protocol similar to RSVP. In other words, a SNSLP message has an expiry period (Refresh period) thereof described therein, and unless another SNSLP message is sent to update a state within the expiry period, the expiry period expires and the resource request becomes ineffective.

FIG. 2A shows a format of an RTCP message containing an SNSLP message.

One of the following values is contained in the zeroth byte of a first word 201 of an RTCP header as a type of the SNSLP message.
129: RES (RESERVE)
130: RRES (RESPONSE_TO_RESERVE)
131: TEA (TEAR)
132: RTEA (RESPONSE_TO_TEAR)
133: NOT (NOTIFY)
135: REP (REPORT)
136: RREP (RESPONSE_TO_REPORT)

Further contained in the first byte is the value “204” indicating that the message is not the one described in a standard document but the one defined by an application.

In addition, a message size is contained in the second and third bytes. Contained in a second word 202 of the RTCP header is an identifier (SSRC/CSRC) of an RTP stream. Further contained in a third byte 203 is a character string (SNSL) indicating that the message is the SNSLP message. Contained in a fourth word 204 and the subsequent words is an SNSLP message body. The SNSLP message body will be described hereinafter.

FIG. 2B shows contents of the message body with the message type being “RES”.

The expiry period (Refresh period) is described in a first word 212 of an RES message. Further described in the following field 213 are QoS request specifications (QoS Desired). FIG. 2C shows contents of the QoS request specifications.

The QoS request specifications includes a requested bandwidth (Bandwidth) 222, a QoS class 223 specified in ITU-T Recommendation. Y.1541, an end-to-end delay (Path latency) 224, an end-to-end packet loss ratio (Path loss ratio) 225, and an end-to-end jitter 226. Other QoS values to be guaranteed can be added to the QoS request specifications.

In this embodiment, the following values can be used as the values of the QoS class 223.

0: conversational class

1: streaming class

2: interactive class

5: best-effort class

In other words, traffic with the QoS class set to “0” in the requested bandwidth being lower than 200 kbps is handled as the EF traffic. At the core router, the first queue is used for the above-mentioned EF traffic. Used as DSCP is the one and only value “46” assigned to EF.

Alternatively, traffic with the QoS class set to “0” in the requested bandwidth being 200 kbps or higher is handled as AF1 traffic, and AF1, in other words, “10” is used as DSCP. At the core router, the second queue is used for the AF1 traffic. By switching between EF and AF1 depending on the requested bandwidth, the priority queue can be prevented from being occupied by traffic with a wide bandwidth. In addition, the voice traffic, which is narrow in bandwidth but sensitive to a delay, can be prevented from being adversely affected. Accordingly, pressure can be prevented from being put on traffic in a non-priority queue.

Alternatively, instead of judgment by the requested bandwidth, conversational voice and conversational video may be handled as the EF traffic and the AF1 traffic, respectively, which can produce similar effects. However, the contents of the QoS request specifications shown in FIG. 2C include no information for judging voice/video, the information for judging voice/video needs to be added to a QoS requirements field. Alternatively, the information for judging voice/video needs to be subjected to judgment by using media information contained in an INVITE message of SIP used upon start of a session and a “200 OK” message that is a response thereto. If information on an SIP message is used, the resource management server 108 needs to receive the information for judging voice/video from an SIP proxy at a time of an INVITE/“200 OK” message exchange.

Further, traffic whose QoS class is “1” or “2” is handled as AF traffic, and AF31 or AF21, respectively, is used as DSCP. At the core router, the third or second queue, respectively, is used for the traffic. On the other hand, traffic whose QoS class is “5” is handled as DF traffic, and the value “0” assigned to DF is used as DSCP. At the core router, the fourth queue is used for the traffic.

FIG. 2D shows contents of the message body with the message type being “REP”.

Described in a field 271 of an REP message is a condition code (0 if there is no abnormality). Described in a field 272 is an expiry period (Refresh period). Further described in a subsequent field 273 is a QoS measurement result (QoS Measured). A format of the QoS measurement result is as shown in FIG. 2C. Further described in a field 274 is an expected QoS value (QoS Expected). A format of the expected QoS value is as shown in FIG. 2C.

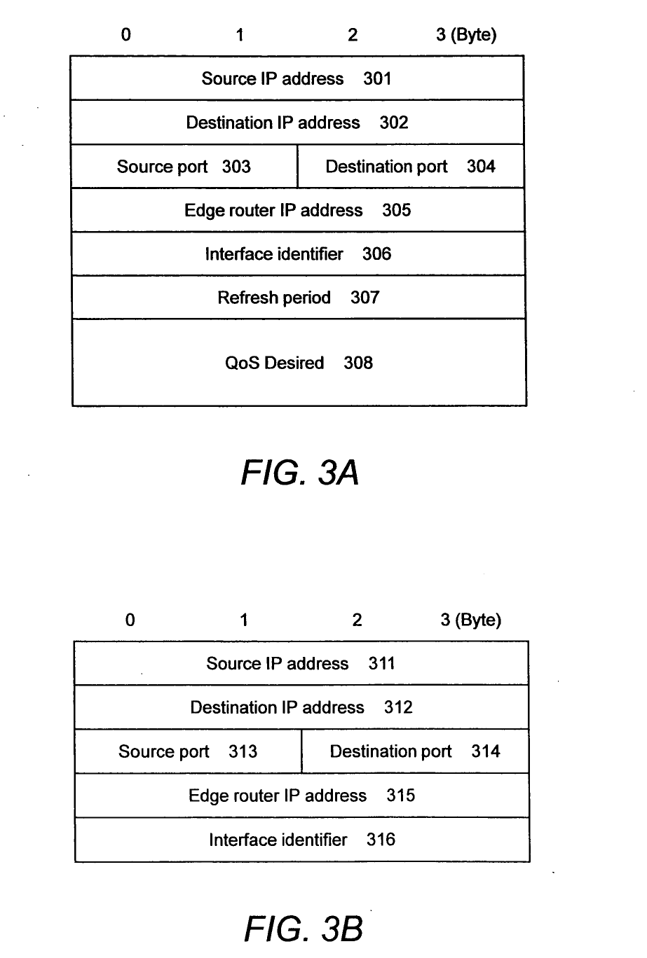

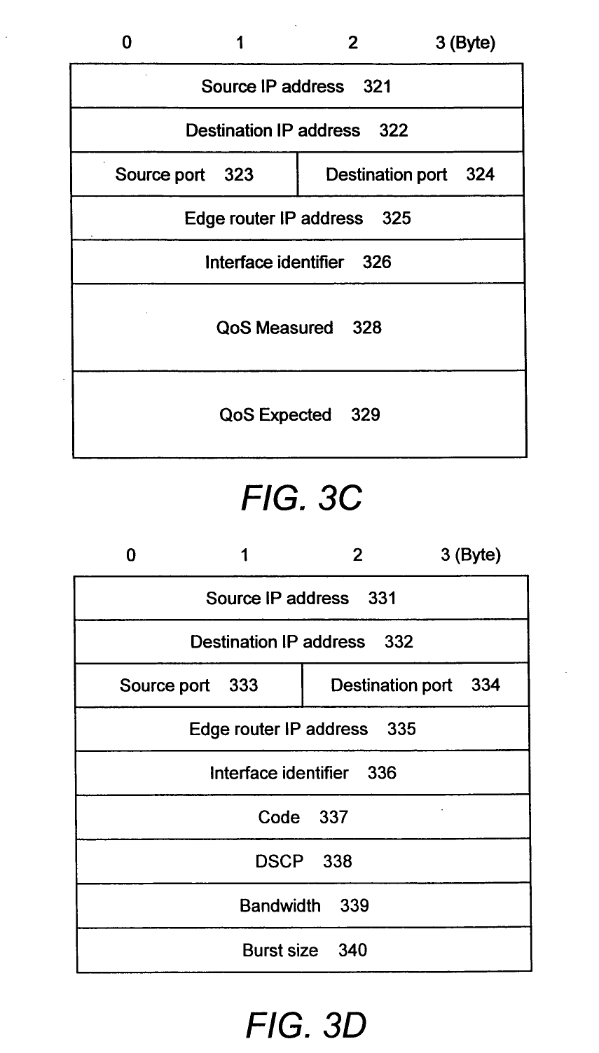

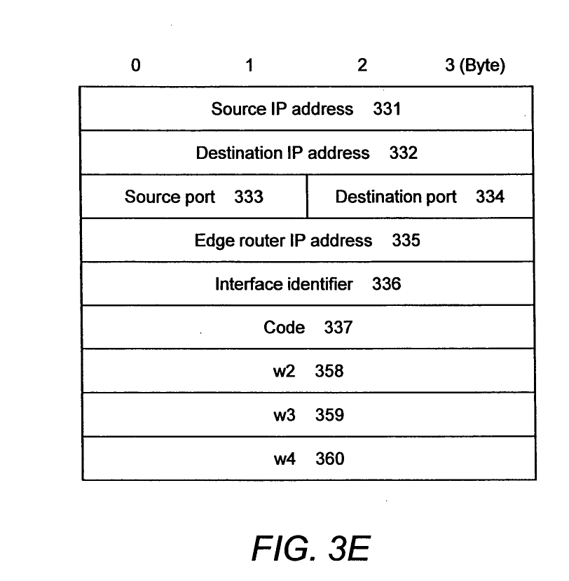

FIGS. 3A to 3E show data formats of a protocol for a policy request/distribution used in the first embodiment of this invention.

As the protocol for the policy request/distribution, Common Open Policy Service (COPS) has already been standardized by the IETF. Accordingly, for the policy request/distribution, COPS may be used, but herein, a non-standard protocol (hereinafter, referred to as “SCOPS”), which is easier to implement, is used. Message types of the protocol for the policy request/distribution include Resource ReQuest (RRQ), Tear ReQuest (TRQ), RePorT (RPT), Decision (DEC), and Response (RSP).

FIG. 3A shows a format of an RRQ type message.

The RRQ type message (resource reservation message) includes the following contents: an IP address 301 and a port identifier 303 of a sender of the resource reservation message; an IP address 302 and a port identifier 304 of a recipient of the resource reservation message; an IP address 305 of a border router that transmits an RRQ message; an identifier (number) 306 of a network interface that has received the resource reservation message; an expiry period 307 of the resource reservation message; and a QoS requirements 308 contained in the resource reservation message. This embodiment handles only communications via RTP, and hence the RRQ type message format does not include description that can distinguish between UDP and TCP, but if the communications via TCP or other such IP protocol are to be handled, a field that represents the IP protocol may be added.

FIG. 3B shows a format of a TRQ type message.

TRQ type message (resource release message) includes the following contents: an IP address 311 and a port identifier 313 of a sender of the resource release message; an IP address 312 and a port identifier 314 of a recipient of the resource release message; an IP address 315 of a border router that transmits a TRQ message; and an identifier (number) 316 of a network interface that has received the resource release message. Also in the TRQ type message format, a field that represents an IP protocol may be added as necessary.

FIG. 3C shows a format of an RPT type message.

The RPT type message (measurement result report message) includes the following contents: an IP address 321 and a port identifier 323 of a sender of the measurement result report message; an IP address 322 and a port identifier 324 of a recipient of the measurement result report message; an IP address 325 of a border router that transmits an RPT message; an identifier (number) 326 of a network interface that has received the measurement result report message; an expiry period 327 of the measurement result report message; a QoS measurement result 328 contained in the measurement result report message; and a QoS measurement result 329 within the network 112 measured at the border router. Also in the RPT type message format, a field that represents an IP protocol may be added as necessary.

FIGS. 3D and 3E show formats of a DEC type message.

The DEC type message has a first format for setting an edge router, which is shown in FIG. 3D, and a second format for setting a core router, which is shown in FIG. 3E. Also in the DEC type message formats, a field that represents an IP protocol may be added as necessary.

FIG. 3D shows the first format of the DEC type message.

This message, in other words, the message format for setting an edge router includes the following contents: an IP address 331 and a port identifier 333 of a sender of a flow for which the resource reservation or the resource release is to be performed (in other words, of the sender of the resource reservation message or resource release message); an IP address 332 and a port identifier 334 of a recipient of the flow for which the resource reservation or the resource release is to be performed (in other words, of the recipient of the resource reservation message or resource release message); an IP address 335 of a border router that transmits an original SCOPS message (RRQ, TRQ, or RPT) to which a DEC message is to be returned; an identifier (number) 336 of a network interface that has received the resource reservation message or the resource release message; a code 337 that represents availability (such as success or failure) of the resource reservation or cancellation of the reservation; a DSCP value 338 that is to be assigned to the above-mentioned flow; a band value 339 that is to be assigned to the above-mentioned flow; and a burst size 340 that is to be assigned to the above-mentioned flow.

FIG. 3E shows the second format of the DEC type message.

This message, in other words, the message format for setting a core router includes the following contents: an IP address 331 and a port identifier 333 of a sender of a flow for which the resource reservation or the resource release is to be performed (in other words, of the sender of the resource reservation message or resource release message); an IP address 332 and a port identifier 334 of a recipient of the flow for which the resource reservation or the resource release is to be performed (in other words, of the recipient of the resource reservation message or resource release message); the IP address 335 of a border router that has transmitted an original SCOPS message (RRQ, TRQ, or RPT) to which a DEC message is to be returned; the identifier (number) 336 of a network interface that has received the resource reservation message or the resource release message; the code 337 that represents availability (such as success or failure) of the resource reservation; and a weight w2 358, a weight w3 359, and a weight w4 360 that are assigned to the three WFQs other than the priority queue at the output interface handled in the settings.

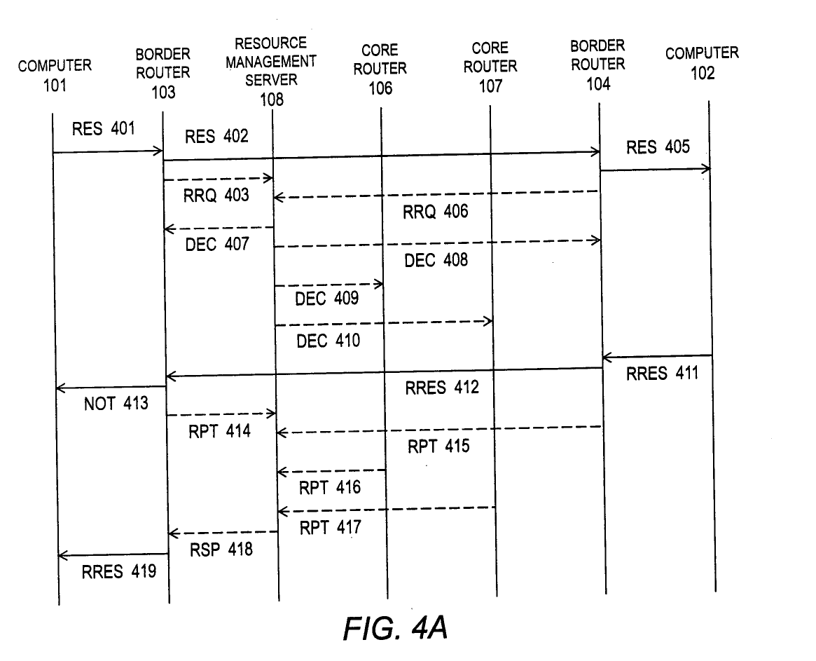

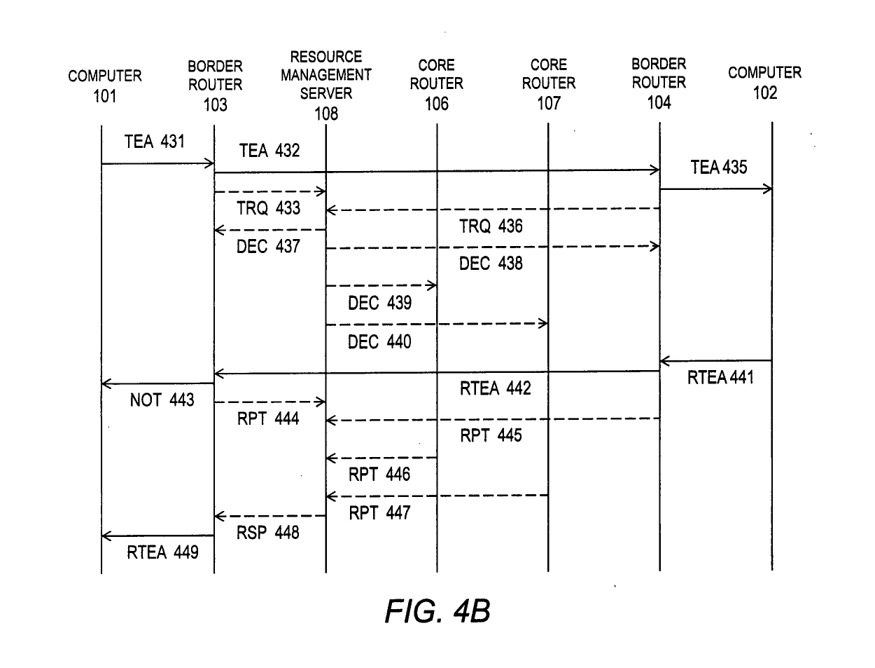

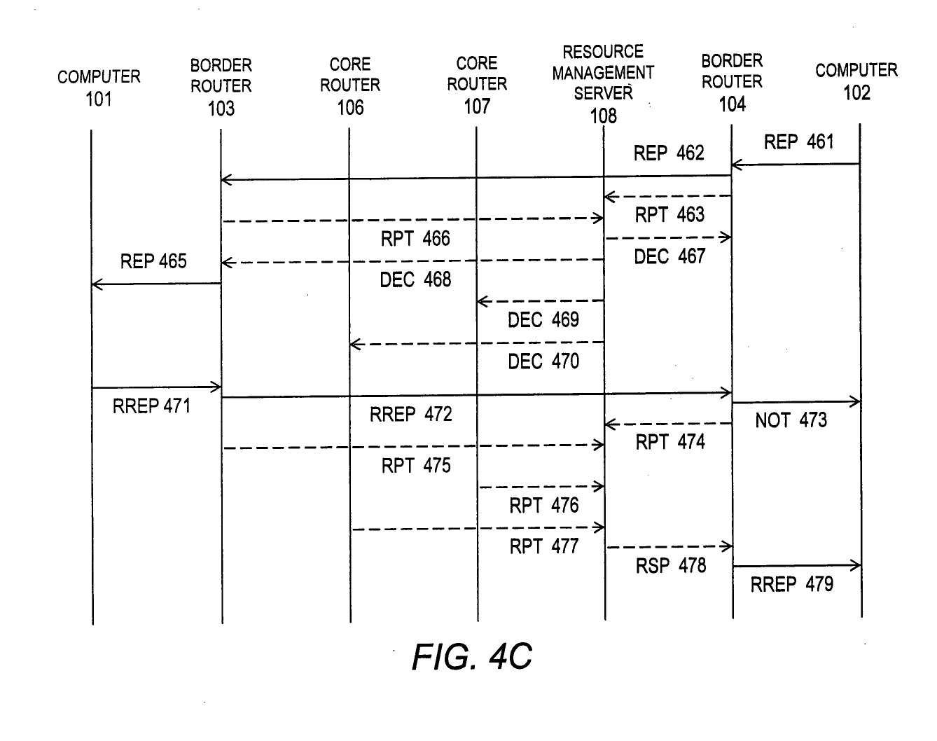

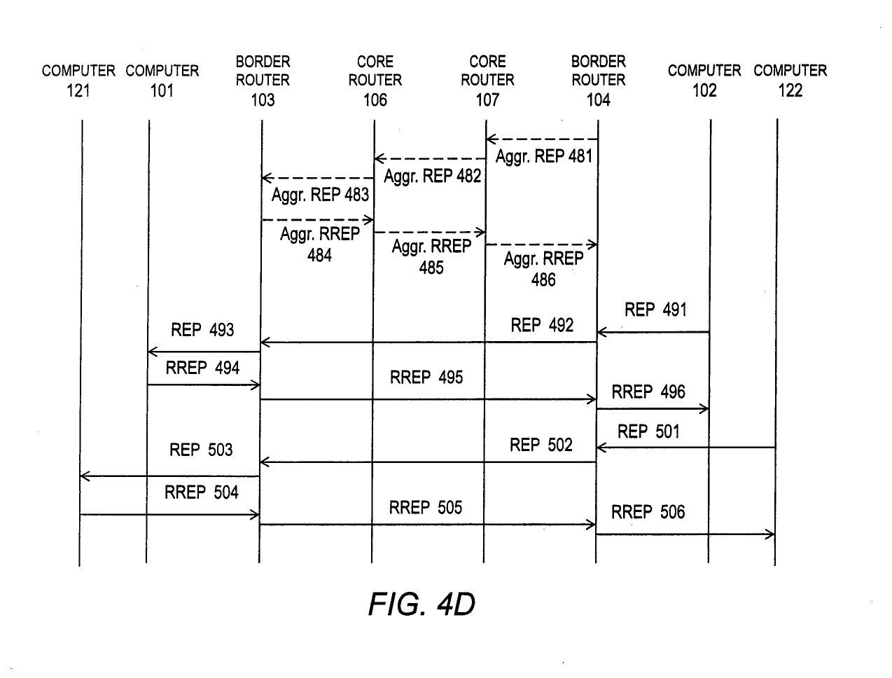

FIGS. 4A to 4D show a communication sequence according to the first embodiment of this invention.

In this embodiment, the computer 101 transmits voice or video to the computer 102 via RTP. Control information is transmitted/received via RTCP. Those communications are in conformity with the IETF standards (RFC 3550 and RFC 3551) related to RTP and RTCP.

First, at the start of communications, the computer 101 transmits a resource request message to the computer 102. During the communications, the computer 102 measures QoS, and transmits a measurement result message to the computer 101 at predetermined timings (for example, periodically). The contents of the measurement result message are used for feedback to a policy. At the end of the communications, the computer 101 transmits the resource release message to the computer 102.

To realize such a communication sequence, a function of transmitting/receiving those messages needs to be built into an application program that runs on the computer 101 and the computer 102. In other words, a subprogram for transmitting a resource request message is built into a program executed by the computer 101 at the start of the communications, and a subprogram for transmitting a resource release message is built into a program executed by the computer 101 at the end of the communications. In addition, a subprogram for receiving the resource request message is built into a program executed by the computer 102 at the start of the communications, and a subprogram for receiving the resource release message is built into a program executed by the computer 102 at the end of the communications. Further, a subprogram for measuring QoS is built into a packet receiving program executed on the computer 102 during the communications, and a subprogram for receiving a measurement result message is built into a program executed on the computer 101 during the communications.

(Resource Request Phase)

FIG. 4A shows a sequence for a resource request according to the first embodiment.

The computer 101 transmits an RES message 401 of SNSLP to the computer 102 (with an IP address of the computer 102 specified as a recipient). The RES message 401 is the resource reservation message for conversational voice. The following values are described in the fields of the RES message 401.

Refresh period: 5000.

Bandwidth: 80000 (bps).

Y.1541 QoS class: 0

Path latency: 100000 (us).

Path loss ratio: 0.001

Path jitter: 5000 (us).

In this embodiment, conversational voice is communicated between the computer 101 and the computer 102. However, even other types of communications can be processed similarly by varying a parameter value contained in the RES message 401.

The RES message 401 is captured at the border router 103 serving as an entrance to the network 112, and forwarded as an RES message 402 as it is, and at the same time, contents thereof are copied to an RRQ message 403 of SCOPS. The RRQ message 403 is transmitted to the resource management server 108. In other words, the IP addresses and port identifiers of the sender and recipient that are contained in an IP header of the RES message are copied to the fields 301 to 304 of the RRQ message, respectively. In addition, the IP address of the border router 103 and the identifier of the network interface that has received the RES message are copied to the fields 305 and 306, respectively. Further, the expiry period of the RES message is copied to the field 307, and the QoS request specifications 213 are copied to the field 308.

The forwarded RES message 402 reaches the border router 104 serving as an exit from the network 112, and forwarded as an RES message 405 as it is, and at the same time, contents thereof are copied to an RRQ message 406 of SCOPS. The RRQ message 406 is transmitted to the resource management server 108. In other words, the contents of the RES message are copied to the RRQ message 406, and at the same time, the IP address of the border router 104 and the identifier of the network interface that has received the RES message are copied to the fields 315 and 316, respectively.

When both the RRQ messages, which relate to one flow (flow from a specified port of the computer 101 to a specified port of the computer 102), are received from the border router 103 and the border router 104 serving as the entrance to and the exit from the network 112 (hereinafter, referred to as “entrance border router 103 and exit border router 104”), respectively, the resource management server 108 decides a policy for the entrance border router 103 which relates to the flow, and transmits the decided policy to the border router 103 as a DEC message 407. The resource management server 108 holds information on each flow in an internal database with the IP address of the sender of the flow and the identifier of the port (UDP port or TCP port) as keys.

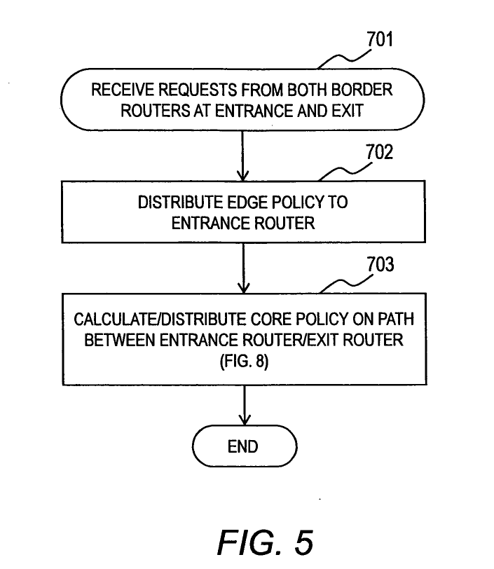

The format of the DEC message 407 is the first format of the DEC type message of SCOPS shown in FIG. 3D. FIG. 5 will be used later to describe a method of deciding a policy for the entrance border router 103 and contents thereof (contents of the DEC message 407).

Further, if there is a need to change policies for the core routers 106 and/or 107, the resource management server 108 transmits DEC messages 409 and/or 410 for changing the policies for the core routers to the core routers 106 and/or 107, respectively. The format of DEC messages 409 and 410 is the second format of the DEC type message of SCOPS shown in FIG. 3E. If there is another need to change a policy for the exit border router 104, the resource management server 108 transmits a DEC message 408 for changing the policy for the border router to the border router 104. The format of the DEC message 408 is the first format of the DEC type message of SCOPS shown in FIG. 3D.

Next, a description will be made of the method of deciding a policy for the entrance border router 103, which is performed by the resource management server 108.

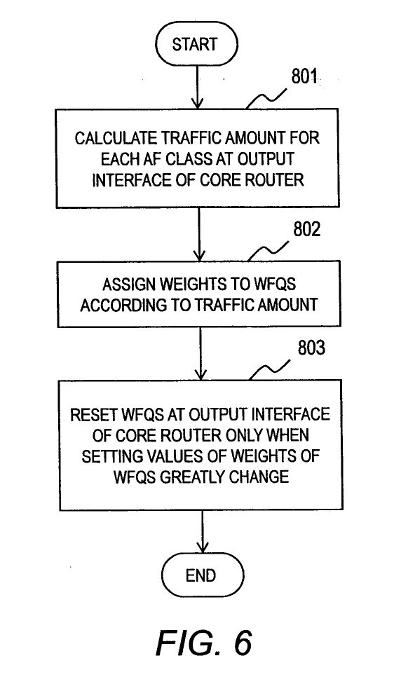

FIG. 5 is a flowchart of a processing of deciding a policy for the entrance border router 103 according to the first embodiment of this invention, and FIG. 6 is a flowchart of a processing of deciding a policy for the core routers 106 and/or 107 according to the first embodiment of this invention.

The policy is decided when both the requests are received from the entrance border router 103 and the exit border router 104 (701). When those requests are both received, in Step 701, the resource management server 108 decides the value of DSCP to be marked based on the values of the QoS class 223 contained in those requests.

Further, the resource management server 108 decides the band value 339 and the burst size 340 for policing based on a band value b contained in those requests and a value d indicating a delay time which is allowed in the network 112 and is equal to or less than a delay time contained in the request. The band value 339 is based on the band value b contained in the request, and the burst size 340 is based on (b/8)×d. The contents of the DEC message 407 are decided based on the band value 339 and the burst size 340. After that, the decided DEC message 407 is transmitted to the entrance border router 103 as an edge policy (702).

The entrance border router 103 has the operation set based on the contents of the DEC message 407 so that when the communication packet from the computer 101 reaches the computer 102, the DSCP marking and the policing are performed.

However, the values contained in the request are not used for calculation of the band value 339 and the burst size 340 as they are, but with the band value and the burst size taken separately, a factor is decided for each flow by using “1” as an initial value (reference value). Then, the band value 339 and the burst size 340 are decided by using a value obtained by multiplying an original value by the factor being greater than 1 or less than 1. The value of the decided factor is described in information on the flow.

It should be noted that in the first embodiment, the entrance border router 103 marks the DSCP value, but the computer 101 may mark the DSCP value. In this case, the computer 101 has a function of a network node for performing the marking as well as the terminal function. At this time, the entrance border router 103 may be set so as to check whether or not an inadequate DSCP value is set, and to discard an inadequate packet.

As described above, in the first embodiment, the resource management server 108 receives messages from the routers located on a communication path between the computer 101 and the computer 102, in other words, the entrance border router 103 and the exit border router 104. Accordingly, without depending on another method, the resource management server 108 can grasp the entrance to and the exit from the network 112 of the flow, which produces an effect that the border routers to be set and paths in the network 112 can be held.

Subsequently, in Step 702, the resource management server 108 calculates a policy for each of core routers on a path between the entrance border router 103 and the exit border router 104, and distributes the calculated policy. In other words, a processing shown in FIG. 6 is executed for each of the core routers. For that end, the path between the entrance border router 103 and the exit border router 104 is decided by a method described as follows.

For example, in a case where the core network is the network having a static path as in MPLS, a path is obtained for each combination of the entrance border router and the exit border router, and the obtained path information is registered in a database with the combination of the entrance border router and the exit border router as a key. Each time a path needs to be obtained, the database is searched.

Alternatively, in a case where a path in the core network dynamically changes, a signaling (message exchange) of the entrance border router 103 and the exit border router 104 is started, and a core router through which a signaling message passes reports an IP address or the like of the core router to the resource management server 108. This allows the resource management server 108 to grasp the path. For such a signaling, RSVP and SNSLP can be used. The entrance border router 103 has a function of starting the signaling based on RSVP and SNSLP from an external by using a command line or XML. The above-mentioned database for a report sent from the core router contains an identifier of the network interface at the exit of each core router.

When the path is thus decided, each of the core routers executes the processing shown in FIG. 6. In the processing shown in FIG. 6, first, a total bandwidth of the respective queues (WFQs) provided to an exit interface of the core router is calculated (801). For that end, the resource management server 108 may hold a value obtained by adding requested bands of flows to which policies have already been assigned, and may add a band newly assigned by the processing shown in FIG. 5 to the total bandwidth. In a case where a weight ratio is obtained from a ratio among the total bandwidths of the respective queues, the weight ratio is set by multiplying the ratio among the total bandwidths by factors with “1” taken as an initial value each of which is decided for each interface and each queue (802).

In a case where the weights that are already assigned to the respective queues lose their balance by the addition of the above-mentioned newly-assigned band, a new weight is decided, and the DEC message 409 or 410 that contains the decided new weight is transmitted (803). However, if there is no need to change the weights that are already assigned, neither the DEC message 409 nor 410 is transmitted. This can suppress overhead that occurs to the core router due to the transmission of the DEC messages 409 and 410. Upon reception of the DEC message 409 or 410, the core routers 106 and 107 changes band distribution according to the contents.

If addition and subtraction are performed alternately in the processing shown in FIG. 6, the DEC messages 409 and 410 are generated every time, and there is a fear that overhead of the core router may increase. Therefore, if a change amount of the bandwidth is within a predetermined range, the policy is not changed.

For example, in a case where: a 2% of bandwidth is assigned to the best-effort traffic; there are two WFQs corresponding to the AF traffic to be adjusted; a ratio between their bandwidths is 1:1; and their factors are each “1”, the weights of the WFQs corresponding to the AF traffic are each 49%. The initial values of the weights are decided as 49% and 49%, and a change allowance width is decided as 3%. In other words, it is decided that the policy be not changed even if the total bandwidth changes by 3%. In other words, the policy is not changed even if the total bandwidth of the first WFQ increases to have the ratio of 52:46. However, if the ratio becomes 53:45, the weights are changed to 53% and 45%.

Herein, if the change allowance width is increased (for example, from 3% to 5%), a change frequency of the policy decreases, which can prevent the setting of the core router from becoming a bottle neck even in a larger-scale network. In other words, the setting of the core router becomes more scalable. However, if the change allowance width is increased, there is a probability that there may occur a situation where the band becomes short in a specific queue although there is enough room in the bands as a whole. On the other hand, if the change allowance width is decreased (for example, from 3% to 1%), the policy increases in change frequency and decreases in scalability, but the bands may be used more effectively.

It should be noted that in the first embodiment, the band distribution is performed based on the WFQs between the AF classes, but it is also possible to assign different priorities to the AF classes. In this case, the core routers 106 and 107 change the priorities if the DEC messages 409 and 410 are received, respectively.

Now returning to FIG. 4A, the description of the sequence will be resumed. Upon reception of the RES message 405, the computer 102 transmits an RRES message 411 as a response to the computer 101 being the sender of the RES message 405 (by specifying the IP address of the computer 101 as the recipient IP address). The border router 104 forwards the RRES message 411 as an RRES message 412 as it is. The forwarded RRES message 412 is captured by the border router 103.

The border router 103 has not yet received an RSP message 418, which is a response to the RRQ message 403 from the resource management server 108, and hence the border router 103 does not forward the RRES message 412 to the computer 101, and instead, transmits an NOT message 413, which is a tentative response to the RES message 401. This is because it may take time for a response to the RES message 401 to reach the computer 101, and by transmitting the NOT message 413, a timeout processing is prevented from being performed on the computer 101. Therefore, if there is no fear of timeout, the NOT message 413 does not need to be transmitted.

Since SNSLP is a non-standard protocol, the existing router does not have a function of processing the SNSLP protocol. If the border router 103 does not have an SNSLP processing function, a router function expansion device 1201 can be used to implement the SNSLP processing function to the border router 103.

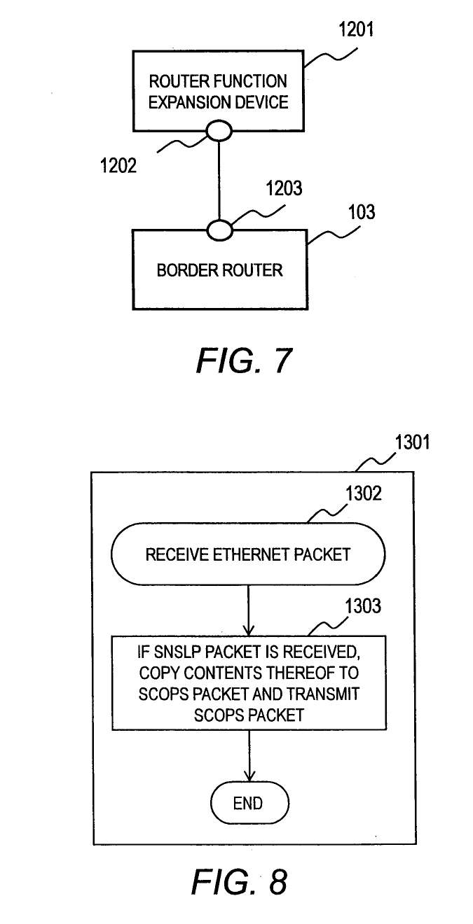

FIG. 7 is a block diagram showing the router function expansion device according to the first embodiment of this invention.

For example, a LAN port 1202 of the router function expansion device 1201 and a LAN port 1203 of the border router 103 are coupled to each other through the LAN cable. The router function expansion device 1201 may be a personal computer in which a router function expansion program is installed.

The border router 103 has a policy routing function. The policy routing function is a function provided to a large number of existing routers. According to settings for policy routing, the border router 103 can forward an SNSLP packet that has reached a port other than the LAN port 1203 of the border router 103 to the router function expansion device 1201. According to the policy routing, the border router 103 can forward only a specific kind of packet selectively to a specific port. However, the border router 103 is set to forward the SNSLP packet to the LAN port 1203 only if the SNSLP packet that has reached is a packet of UDP, which is a protocol subordinate to SNSLP, and contains a predetermined UDP port number.

SNSLP is implemented on RTCP. Used for RTCP communications is a UDP port having a port number “p+1” which is larger by “1” than a UDP port having a port number “p” which is used for the communications via RTP between the computer 101 and the computer 102. Therefore, if a range of the port number of the UDP port of RTP used for communications is predefined, it is possible to judge the UDP port of RTCP corresponding to the predefined range. Accordingly, as described above, it is possible to forward the SNSLP packet to the LAN port 1203. The packet forwarded to the LAN port 1203 is captured by the router function expansion program at the LAN port 1202.

Next, a description will be made of an operation of the router function expansion program 1301.

FIG. 8 is a flowchart showing a processing executed by the router function expansion program according to the first embodiment of this invention.

The router function expansion program 1301 uses a promiscuous mode (in other words, communication mode configured to make it possible to handle even a packet with the computer concerned excluded from a destination address by specifying information not on a generally-used IP layer but on the second layer of the OSI model), which is implemented on Linux and the like, to capture all of Ethernet packets that reach the LAN port 1202, including packets other than the IP packets.

When the Ethernet packet reaches the LAN port 1202 (1302), a program shown in FIG. 8 is started, and Step 1303 is executed. In other words, if the received packet is an SNSLP packet, the contents of the received SNSLP packet are copied to generate an SCOPS packet, and the generated SCOPS packet is transmitted to the resource management server 108.

However, if the border router 103 forwards the SNSLP packet as an ordinary Ethernet packet, the forwarded packet does not contain information indicating which interface of the border router 103 the SNSLP packet has reached. Therefore, the information, which is to be described as the network interface identifier 306 shown in FIG. 3A when the SCOPS message is generated, cannot be known.

The above-mentioned problem may be solved as follows. In a network between the LAN port 1202 and the LAN port 1203, a tag VLAN is used to previously decide a correspondence between the network interface and a VLAN number. In a case where the border router 103 performs the policy routing, the VLAN number corresponding to the network interface that has been reached by the SNSLP packet may be specified. Then, if the router function expansion program 1301 receives the SNSLP packet, the network interface identifier corresponding to the VLAN number may be obtained, and the obtained network interface identifier may be described in the field 306. The processing that has been described above may be applied not only at a resource request time but also at a resource release time and a measurement result transmission time which will be described as follows.

Now returning to FIG. 4A, the description of the sequence will be resumed. If the DEC message 407 is received, the border router 103 performs settings as described below. If a flow containing the IP addresses and port identifiers of the sender and recipient that are contained in the DEC message 407 is detected, the DSCP value 338 contained in the DEC message 407 is marked in the detected flow (packet). In addition, if there is a flow from which traffic exceeding the specified band value 339 is detected, the policing is performed (in other words, the traffic is limited so as not to exceed the specified band value). However, a burst having the burst size 340 specified in the detected flow is allowed.

At present, there is a router that can perform such settings by commands. However, in a case where the router that can perform such settings cannot directly receive the DEC message 407, the DEC message 407 is received by the router function expansion device 1201, the router function expansion device 1201 issues a flow QoS command, and the border router 103 may be configured to perform the settings by the issued command.

Upon completion of the policy settings based on the DEC message 407, the border router 103 transmits an RPT message 414 to the resource management server 108 as a response thereto. If the router function expansion device 1201 receives the DEC message 407, the router function expansion device 1201 transmits the RPT message 414 to the resource management server 108. Also in a case where the border router 104 receives the DEC message 408, upon completion of the policy settings based on the received DEC message 408, the border router 104 transmits an RPT message 415 to the resource management server 108 as a response to the DEC message 408. If the border router 104 cannot directly receive the DEC message 408, the router function expansion device 1201 is provided to the border router 104, and the router function expansion device 1201 may substitute the border router 104 to perform the processing thereof.

If the core routers 106 and 107 receive the DEC messages 409 and 410, respectively, such settings as described below are performed. In other words, the weights w2, w3, and w4 are assigned to the second to fourth queues, respectively. However, the weights have already been set initially, and hence the settings are performed by updating the set weights.

Upon completion of the policy settings based on the DEC messages 409 and 410, the core routers 106 and 107 also transmit RPT messages 416 and 417 to the resource management server 108 as responses to the DEC messages 409 and 410, respectively. If the core routers 106 and/or 107 cannot directly receive the DEC messages 409 and 410, respectively, the router function expansion device 1201 is provided to the core routers 106 and/or 107, and the router function expansion device 1201 may substitute the core routers 106 and/or 107 to perform the processings/processing thereof.

Upon completion of all of the policy settings, in other words, upon reception of all of the RPT messages 414, 415, 416, and 417, the resource management server 108 transmits the RSP message 418 to the border router 103 as a response to the RRQ message 403. If the RRES message 412 has already been received, upon reception of the RSP message 418, the border router 103 forwards the RRES message 412 to the computer 101 as an RRES message 419. If the RRES message 412 has not been received yet, upon reception of the RRES message 412, the border router 103 transmits the RRES message 419 to the computer 101.

(Resource Release Phase)

FIG. 4B shows a sequence followed at the resource release time according to the first embodiment of this invention.

The computer 101 transmits a TEA message 431 of SNSLP to the computer 102 (with the IP address of the computer 102 specified as the recipient). The TEA message 431 is captured at the border router 103 serving as the entrance to the network 112, and forwarded as a TEA message 432 as it is, and at the same time, contents thereof are copied to a TRQ message 433 of SCOPS. The TRQ message 433 is transmitted to the resource management server 108. In other words, the IP addresses and port identifiers of the sender and recipient that are contained in an IP header of the TEA message are copied to the fields 301 to 304 of the TRQ message, respectively, and the IP address of the border router 103 and the identifier of the network interface that has received the TEA message are copied to the fields 305 and 306, respectively.

When the forwarded TEA message 432 reaches the border router 104 serving as the exit from the network 112, the TEA message 432 is forwarded as a TEA message 435 as it is, and at the same time, contents thereof are copied to a TRQ message 436 of SCOPS and transmitted to the resource management server 108. In other words, the contents of the TEA message 432 are copied to the TRQ message 436, and at the same time, the IP address of the border router 104 and the identifier of the network interface that has received the TEA message 435 are copied to the fields 315 and 316, respectively.

If the TRQ message 436 is received from the entrance border router 103, the resource management server 108 transmits a DEC message 437 to the border router 103 in order to delete the policy for the entrance border router 103 related to a flow for which a resource is to be released. The DEC message 437 is of the first format of the DEC message of SCOPS shown in FIG. 3D.

Further, if there is a need to change policies for the core routers 106 and/or 107, the resource management server 108 transmits DEC messages 439 and/or 440 for changing the policies to the core routers 106 and/or 107, respectively. The DEC messages 439 and 440 are of the second format of the DEC message of SCOPS shown in FIG. 3E. If there is another need to delete the policy for the exit border router 104, the resource management server 108 transmits a DEC message 438 to the border router 104. The DEC message 438 is of the first format of the DEC message of SCOPS shown in FIG. 3D.

Upon reception of the TEA message 435, the computer 102 transmits an RTEA message 441 as a response to the computer 101 being the sender of the TEA message 435 (by specifying the IP address of the computer 101 as the recipient IP address). The border router 104 forwards the RTEA message 441 as an RTEA message 442 as it is. The forwarded RTEA message 442 is captured by the border router 103.

The border router 103 has not yet received an RSP message 448, which is a response to the TRQ message 433 from the resource management server 108, and hence the border router 103 does not forward the RTEA message 442 to the computer 101, and instead, transmits an NOT message 443, which is a tentative response to the TEA message 431. This is because it may take time for a response to the TEA message 431 to reach the computer 101, and by transmitting the NOT message 443, the timeout processing is prevented from being performed on the computer 101. Therefore, if there is no fear of timeout, the NOT message 443 does not need to be transmitted.

If the DEC message 437 is received, the border router 103 performs settings as described below. If a flow containing the IP addresses and port identifiers of the sender and recipient that are contained in the DEC message 437 is detected, the settings for this flow stored in the border router 103 in terms of the marking and policing are cleared.

Upon completion of the policy settings based on the DEC message 437, the border router 103 transmits an RPT message 444 to the resource management server 108 as a response thereto. Also in a case where the border router 104 receives the DEC message 438, upon completion of the policy settings based on the received DEC message 438, the border router 104 transmits an RPT message 445 to the resource management server 108 as a response thereto.

If the core routers 106 and 107 receive the DEC messages 439 and 440, respectively, such settings as described below are performed. In other words, the weights w2, w3, and w4 are assigned to the second to fourth queues, respectively. However, the weights have already been set initially, and hence the settings are performed by updating the set weights.

In a case where the resource management server 108 decides the policy for the entrance border router 103, the processing shown in FIG. 5 may be used in a similar manner to the resource request time. However, in Step 702, the contents of the DEC message 437 are decided so as to clear the settings related to the flow concerned. In other words, a code for reservation cancellation is specified as the code 337.

Subsequently, in Step 702, the resource management server 108 calculates the policy for each of the core routers on the path between the entrance border router 103 and the exit border router 104, and distributes the calculated policy. In other words, the processing shown in FIG. 6 is executed for each of the core routers.

In the processing shown in FIG. 6, first, the total bandwidth of the respective queues (WFQs) provided to the exit interface of the core router is calculated. For that end, the resource management server 108 may hold the value obtained by adding the requested bands of the flows to which policies have already been assigned, and may subtract a band for which the assignment has been canceled by the processing shown in FIG. 5 from the total bandwidth. In a case where the weights that are already assigned to the respective queues lose their balance by the subtraction, weights are newly decided, and the DEC messages 439 and 440 that contain the decided new weights are transmitted. However, if there is no need to change the weights that are already assigned, neither the DEC message 439 nor 440 is transmitted. This can suppress overhead that occurs to the core router due to the transmission of the DEC messages 439 and 440.

Upon completion of the policy settings based on the DEC messages 439 and 440, the core routers 106 and 107 also transmit RPT messages 446 and 447 to the resource management server 108 as responses to the DEC messages 439 and 440, respectively.

Upon completion of all of the policy settings, in other words, upon reception of all of the RPT messages 444, 445, 446, and 447, the resource management server 108 transmits the RSP message 448 to the border router 103 as a response to the TRQ message 433. If the RTEA message 442 has already been received, upon reception of the RSP message 448, the border router 103 forwards the RTEA message 442 to the computer 101 as an RTEA message 449. If the RTEA message 442 has not been received yet, upon reception of the RTEA message 442, the border router 103 transmits the RTEA message 449 to the computer 101.

(Feedback Phase)

FIG. 4C shows a sequence followed at the measurement result transmission time (in other words, at a feedback time) according to the first embodiment of this invention.

The computer 102 transmits an REP message 461 of SNSLP to the computer 101 (with an IP address of the computer 101 specified as the recipient). A message is transmitted in a direction reverse to the cases of the resource reservation (FIG. 4A) and the resource release (FIG. 4B). In the IP network, a packet does not always pass along the same route in a case where a message is transmitted in a different direction. However, in this embodiment, the packet needs to pass along the same border router (in other words, the border routers 104 and 103). A mechanism for forwarding a message in a reverse direction along the same route for transmitting the message in the above-mentioned manner is realized by RSVP. Therefore, in a network (for example, IP network) in which different routes may be used in different forwarding directions, the same mechanism as RSVP may be used.

The REP message 461 is of the format shown in FIG. 3C, in which the QoS measurement result (QoS Measured) 328 is of the format shown in FIG. 2C, indicating measurement values related to QoS. Major examples of the measurement values related to QoS include a delay time, jitter, and a packet loss ratio, each of which can be obtained as follows.

First, the delay time 224 can be obtained as follows. Each time the computer 102 receives an RTP packet and an RTCP packet transmitted from the computer 101 during communications, the computer 102 measures the delay time, and records the measured delay time. After that, an REP message is transmitted with the measurement result described in the QoS measurement result (QoS Measured) 328.

In other words, each time a Sender Report (SR) packet of RTCP is received, the transmission time contained in the SR packet is recorded. Each time an RTP packet reaches, the transmission time of the RTP packet is obtained from a timestamp contained in the RTP packet and the above-mentioned transmission time of the SR packet. Then, by obtaining a difference between the transmission time and reception time of the RTP packet, it is possible to obtain the delay time of the packet concerned.

The above-mentioned transmission time is a time measured based on an internal clock of the computer 101, while the above-mentioned reception time is a time measured based on an internal clock of the computer 102. Those internal clocks of the computers can be adjusted to each other at a high precision (of, for example, 1 millisecond or less) by synchronization via Network Time Protocol (NTP), which is an IETF-standard protocol. Accordingly, the delay time can also be obtained at a precision of substantially 1 millisecond. However, in a case where the internal clocks do not synchronously work with accuracy, it is possible to correct a measurement value and obtain a high precision (of, for example, 10 microseconds or less) by using methods disclosed in, for example: Sue B. Moon et al., “Estimation and Removal of Clock Skew from Network Delay Measurements”, IEEE Infocom 1999, March 1999, p. 227-234; Li Zhang et al., “Clock Synchronization Algorithms for Network Measurements”, IEEE Infocom 2002, July 2002, p. 160-169; and Kostas G. Anagnostakis et al., “cing: Measuring Network-Internal Delays Using Only Existing Infrastructure”, IEEE Infocom 2003, April 2003, p. 2112-2121.

Second, the jitter 226 can be obtained by accumulating the delay times that are thus obtained and calculating a standard deviation of the accumulated delay times. However, if the jitter cannot be obtained with accuracy by the above-mentioned method, the following methods can be employed instead.

The RTP packet is generally transmitted at constant intervals. In a case where it is presupposed that packet transmission intervals be sufficiently accurate at a transmitting end, an estimated value of the jitter can be obtained by obtaining deviations of packet transmission intervals at a receiving end from an original packet transmission interval and calculating a root mean square of the deviations.

Third, the packet loss ratio 225 can be obtained as follows. The RTP packet is given a sequence number, and a series of sequence numbers are assigned to the RTP packet to be transmitted. Therefore, if there is a missing sequence number at the receiving end, it can be judged that a packet to which the missing sequence number is assigned has been discarded midway through the communication. Accordingly, the packet loss ratio can be obtained by calculating a proportion of discarded packets within a predetermined range of sequence numbers.

The QoS measurement result (QoS Measured) 328 also includes the fields of the bandwidth 222 and the QoS class 223, which are not used for indicating a measurement value.

The REP message 461 sent out from the computer 102 is captured by the border router 104 serving as the exit from the network 112, and forwarded as an REP message 462 as it is, and at the same time, contents thereof are copied to an RPT message 463 of SCOPS, which is transmitted to the resource management server 108. In other words, the IP addresses and port identifiers of the sender and recipient that are contained in the IP header of the REP message are copied to the fields 301 to 304 of the RPT message, respectively, and the IP address of the border router 104 and the identifier of the network interface that has received the REP message are copied to the fields 305 and 306, respectively.

The forwarded REP message 462 reaches the border router 103 serving as the entrance to the network 112, and contents thereof are copied to an RPT message 466 of SCOPS, which is transmitted to the resource management server 108. In other words, the contents of the REP message are copied to the RPT message 466, and the IP address of the border router 103 and the identifier of the network interface that has received the REP message are copied to the fields 325 and 326, respectively.

When both the RPT messages, which relate to one flow (flow from the specified port of the computer 101 to the specified port of the computer 102), are received from the entrance border router 103 and the exit border router 104 with respect to the network 112, the resource management server 108 changes the policy for the entrance border router 103 which relates to the flow as necessary. For that end, the resource management server 108 transmits a DEC message 468 to the border router 103. The DEC message 468 is of the first format of the DEC message of SCOPS shown in FIG. 3D.

Further, if there is a need to change policies for the core routers 106 and/or 107, the resource management server 108 transmits DEC messages 470 and/or 469 for changing the policies to the core routers 106 and/or 107, respectively. The DEC messages 469 and 470 are of the second format of the DEC message of SCOPS shown in FIG. 3E. If there is another need to change the policy for the exit border router 104, the resource management server 108 transmits a DEC message 467 to the border router 104. The DEC message 467 is of the first format of the DEC message of SCOPS shown in FIG. 3D.

Next, description will be made of a processing of the resource release phase, which is performed by the resource management server 108. The processing of the resource release phase is the same as the processing of the resource request phase except for the deletion of a policy.

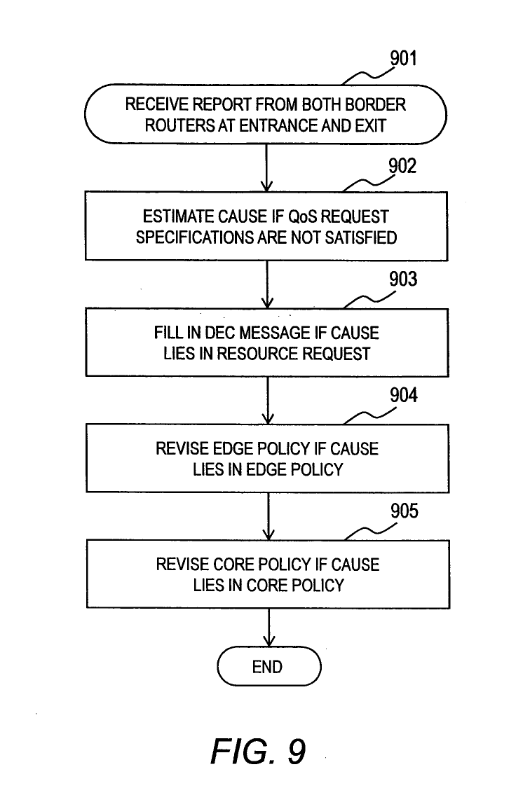

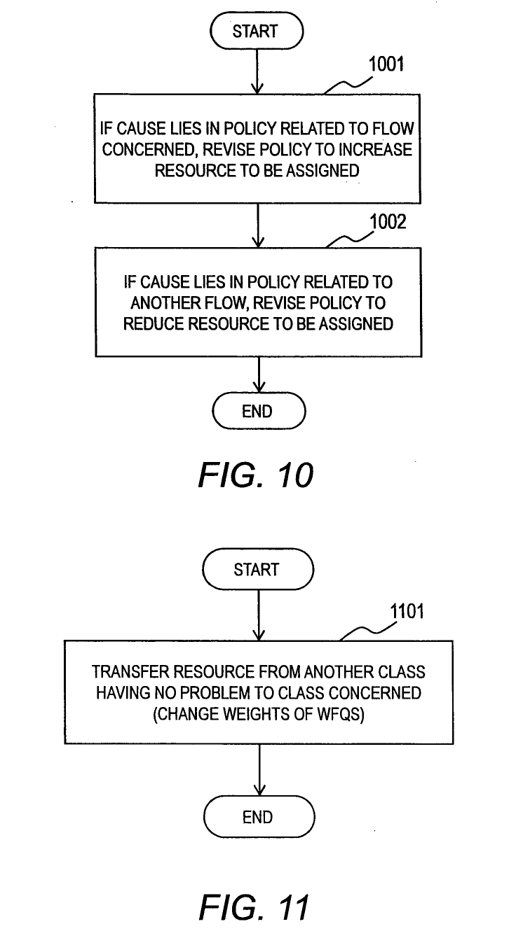

FIG. 9 is a flowchart of a processing of revising a policy by a policy server at the feedback time according to the first embodiment of this invention, FIG. 10 is a flowchart of a processing of updating an edge policy according to the first embodiment of this invention, and FIG. 11 is a flowchart of a processing of updating a core policy according to the first embodiment of this invention.

As shown in FIG. 9, the resource management server 108 decides a policy to be changed, and transmits the DEC messages 467, 469, 470, and 468 as necessary.

Specifically, upon reception of an RPT message from both the entrance border router 103 and the exit border router 104 (901), the resource management server 108 first performs Step 902. In other words, based on the identification information (IP addresses and port identifiers) of the RTP sender and recipient contained in the RPT message, the resource management server 108 identifies an RTP flow, and searches for a QoS request value related to the identified RTP flow. By comparing the QOS measurement value stored in the RPT message and the retrieved QoS request value, if the request value is not satisfied, the resource management server 108 estimates the cause.

In Step 903, if it is judged that the cause lies in a resource request as a result of the estimation performed in Step 902, the condition code 337 of the DEC message 468 is filled in with a code corresponding to the resource request. The DEC message 468 having the condition code 337 filled in is transmitted to the border router 103.

For example, if the computer 101 is transmitting traffic exceeding the request (request made by the RES message 401), it is judged that the cause lies in the resource request. It can be judged whether or not the cause lies in the resource request by receiving statistical information related to the policing of the flow concerned from the border router 103 aside from the sequence shown in FIG. 4C (for example, after the border router 103 transmits a show QoSip-flow command) to judge whether or not an abnormal policing occurs. With regard to all of the flows for which the policies are set, the statistical information is received from the border router 103, and the received statistical information may be recorded.

In the DEC message 468, the DSCP value 338, the band value 339, and the burst size 340 can be described, and those fields can be used for notifying reference values to be used when the computer 101 revises resource request. In other words, in a case where it is estimated that the QoS class contained in the resource request is inadequate, a DSCP value corresponding to the QoS class estimated to be adequate can be described in the field 338. For example, if the conversational class is specified with respect to the TCP traffic, it is estimated that the QoS class is inadequate.

In addition, in a case where it is estimated that the band contained in the resource request is too small, the band value considered to be adequate can be described in the field 339.

The contents of the DSCP value 338, the band value 339, and the burst size 340 contained in the DEC message 468 are copied to the REP message 465. If the REP message 465 is received, the computer 101 can revise the resource request by using those values contained in the REP message 465 to issue a resource request message. This produces an effect that an inadequate request can be corrected.

In Step 904, if it is judged that the cause lies in an edge policy distributed to the border router 103 by the resource management server 108 as a result of the above-mentioned estimation, the edge policy concerned is updated based on the DEC message 468. Specifically, the edge policy is updated according to a procedure shown in FIG. 10.

First, in Step 1001, if it is judged that the cause lies in the edge policy related to the flow concerned, the edge policy judged to involve the cause is updated. In other words, if the packet discard rate is larger than the request value and in at least one of cases where: the band value specified in the policing of the edge policy concerned is set to be small; and the burst size is set to be small (in other words, in a case where a policing factor is too small), it is judged that the cause lies in the edge policy concerned, and the band value and/or the burst size specified in the policing is reset to be large (the policing factor is increased).

This produces an effect that the QoS of the flow concerned can be improved to fall within a requested range. However, since an optimum value specified in the policing may change depending on conditions, it is difficult to obtain the optimum value and set the obtained optimum value. If there is a remarkable change in the policing specification, the network may be destabilized, and hence a change amount may be set to be small (in other words, a feedback amount may be suppressed), and readjusted at the next measurement time.

Subsequently, in Step 1002, if it is judged that the cause lies in an edge policy related to another flow (for example, a communication between the computer 121 and the computer 122), the edge policy judged to involve the cause is updated. In other words, if the packet discard rate, the delay, the jitter, and/or the like is larger than the request values and in a case where the band value and/or the burst size specified in the policing of another edge policy are set to be large (in other words, in a case where the policing factor is too large), it is judged that the cause lies in the another edge policy, and the band value and/or the burst size specified in the policing is reset to be small (the policing factor is decreased).

This produces an effect that the QoS of the flow concerned can be improved to fall within a requested range while keeping the QoS of another flow within the requested range.

Returning to the processing shown in FIG. 9, in Step 905, if it is judged that the cause lies in a core policy distributed to the core routers 106 and/or 107 by the resource management server 108 as a result of the above-mentioned estimation, the core policy is updated by the DEC message 469 and/or the DEC message 470. For example, it is judged that the cause lies in the core policy in a case where a problem (such as the delay and/or jitter being too large) occurs to the class concerned (flow group that uses DSCP assigned to the flow concerned) while there is room for another class (flow group that uses another DSCP). In such a case, the core policy is updated according to a procedure shown in FIG. 11.

In other words, in Step 1101, a resource is transferred from another class having no problem to the class concerned. In other words, upon calculation of the weights assigned to the WFQs, the factor for the class concerned is increased while the factor for another class is decreased. This produces an effect that the QoS of the flow belonging to the class concerned can be improved to fall within a requested range while keeping the QoS of the flow belonging to another class within the requested range. In particular, in a case where a first flow of the class concerned is not provided with a feedback mechanism (in other words, the processing at the feedback time according to this embodiment is not performed), if a second flow of the class concerned is provided with the feedback mechanism, this improves the QoS of all of the flows belonging to the class concerned, thereby producing an effect that the QoS of the first flow also improves.

The entrance border router 103 basically forwards the contents of the REP message 462 as they are to the computer 101 as the REP message 465. However, if it is judged based on the DEC message 468 that the resource request is inadequate, the contents of the inadequate resource request are reflected onto the REP message 465. In other words, the condition code 271 is filled in with a code corresponding to the condition code 337 of the DEC message 468. Further, if the DEC message 468 is filled in with the reference band value 339, the filled reference band value is set as the band value for the expected QoS value (QoS Expected) 274. In a case where the reference value is filled for the QoS class, the filled reference value for the QoS class is set as the QoS class of the expected QoS value (QoS Expected) 274.

Upon reception of the REP message 465, the computer 101 transmits an RREP message 471 as a response to the computer 102 being the sender of the REP message 465 (by specifying the IP address of the computer 102 as the recipient IP address). The border router 103 forwards the RREP message 471 as an RREP message 472 as it is. The forwarded RREP message 472 is captured by the border router 104.

The border router 104 has not yet received an RSP message 478, which is a response to the RPT message 463 from the resource management server 108, and hence the border router 104 does not forward the RREP message 472 to the computer 102, and instead, transmits an NOT message 473, which is a tentative response to the REP message 461. This is because it may take time for a response to the REP message 461 to reach the computer 101, and by transmitting the NOT message 473, the timeout processing is prevented from being performed on the computer 102. Therefore, if there is no possibility of timeout, the NOT message 473 need not be transmitted.

If the DEC message 467 is received, the border router 104 performs settings as described below. If a flow containing the IP addresses and port identifiers of the sender and recipient that are contained in the DEC message 467 is detected, the DSCP value 338 contained in the DEC message 467 is marked in the detected flow (packet). In addition, if there is a flow from which the traffic exceeding the specified band value 339 is detected, the policing is performed (in other words, the traffic is limited so as not to exceed the specified band value). However, a burst having the burst size 340 specified in the detected flow is allowed. However, the settings related to the flow concerned have already existed, and hence settings are performed by updating the existing settings.

Upon completion of the policy settings based on the DEC message 467, the border router 104 transmits an RPT message 474 to the resource management server 108 as a response thereto. Also in a case where the border router 103 receives the DEC message 468, upon completion of the policy settings based thereon, the border router 103 transmits an RPT message 475 to the resource management server 108 as a response thereto.

If the core routers 106 and 107 receive the DEC messages 470 and 469, respectively, such settings as follows are executed. In other words, the weights w2, w3, and w4 are assigned to the second to fourth queues, respectively. However, the settings of the weights have already existed, and hence the settings are performed by updating the existing settings.

Upon completion of the policy settings based on the DEC messages 470 and 469, the core routers 106 and 107 also transmit RPT messages 477 and 476, respectively, to the resource management server 108 as responses thereto.

Upon completion of all of the policy settings, in other words, upon reception of all of the RPT messages 474, 475, 476, and 477, the resource management server 108 transmits the RSP message 478 to the border router 104 as a response to the RPT message 463. If the RREP message 472 has already been received, upon reception of the RSP message 478, the border router 104 forwards the RREP message 472 to the computer 102 as an RTEA message 479. If the RREP message 472 has not been received yet, upon reception of the RREP message 472, the border router 104 transmits the RREP message 479 to the computer 102.

The first embodiment described above produces the following effects. First, the QoS measurement result is fed back by using the same protocol stack as the resource request time and the resource release time, which eliminates the need to develop a new protocol stack. Accordingly, it is possible to effectively suppress the development costs.

Second, the message for feeding back the QoS measurement result passes through the same path and uses the same mechanism between the resource request time and the resource release time, which makes it easy to effectively adjust the resource. In addition, the need for arbitration between a plurality of mechanisms is effectively eliminated.

Third, the core router does not process the messages for the resource request, the resource release, and the measurement result feedback, and the resource management server performs settings on the core router only once every plurality of times of messaging. Accordingly, it is possible to effectively reduce the load on the core network compared to the method of processing the messages for the resource request and the like by all of the routers. In addition, it is possible to effectively realize the scalable QoS guarantee.

Fourth, the problems caused by the inadequate band distribution and the like across the core network are the problems for the whole flows belonging to the QoS class concerned. Therefore, without feedback of results from the measurements of all of the flows, the band distribution is corrected based on the feedback from some of the flows. Accordingly, even the QoS of the flow for which neither measurement nor feedback has been performed can be effectively improved.

### Second Embodiment

Next, description will be made of a second embodiment of this invention.

The second embodiment is the same as the first embodiment except for the contents of each message at the measurement result transmission time (in other words, at the feedback time) and the processing contents of each device. In the second embodiment, as described below, if there occurs a problem with QoS, first, an application (in particular, a receiving-end application) is caused to participate in solution of the problem with QoS, and second, the solution is shared among a plurality of network devices and/or a plurality of networks on a communication path. It should be noted that in the second embodiment, there is shown an example where the above-mentioned first and second characteristics are both applied to the network system of the first embodiment, only one of the first and second characteristics may be applied to the network system of the first embodiment.

Causing the application to participate in problem solution has such a meaning as described below. In the first embodiment, if the request value is not satisfied, and a transmitting-end application may be suggested to change the request value in order to solve this problem, but the receiving-end application does not participate in solution of the problem. However, there is a case where the receiving-end application can play a role for solving the problem.

For example, in a case where the measurement result for the delay satisfies the request specification but the measurement result for the jitter is larger than the request specification, if the receiving-end application can increase a size of jitter buffer, it is possible to maintain a quality of an output from the application even if the request specifications at a time of reception are loosened. In such a case, it is possible to solve the problem with QoS in collaboration between the network and the application.

Further, sharing the problem solution among a plurality of network devices and/or a plurality of networks on a communication path has such a meaning as described below. The network system shown in FIG. 1 includes three networks (in other words, the networks 110, 112, and 111) between the computer 101 and the computer 102. In the first embodiment, except for the computer 101, an appropriate processing is performed in a case where the cause of lowering QoS lies in the network 112 (in other words, between the entrance border router 103 and the exit border router 104). If the networks 110 and 111 have the same structure as the network 112, those networks can perform the same feedback processing. However, if the networks 110, 111, and 112 perform the feedback processing without cooperating with one another, an excessive QoS improvement may be made, leading to the high cost.

Further, as a result of attempting to excessively improve the QoS of a specific flow and/or a specific class, another flow and/or class may be adversely affected. In the second embodiment, those problems are solved by exchanging information between the network and the application and between the networks.

In the second embodiment, the sequence followed at the measurement result transmission time is as shown in FIG. 4C. Further, the contents of the QoS measurement result 328 contained in the REP message 461 are also the same. However, the expected QoS value (QoS Expected) 274 is used to exchange information between the recipient and the network, between the networks, and between the network devices.

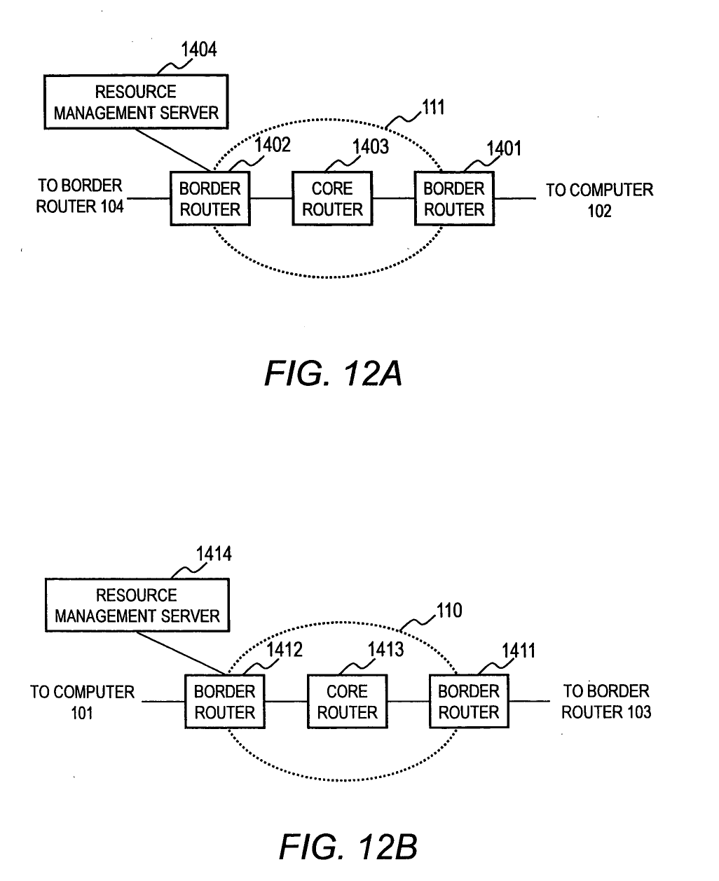

FIG. 12A is a block diagram showing a configuration of the access network 111 according to the second embodiment of this invention, and FIG. 12B is a block diagram showing a configuration of the access network 112 according to the second embodiment of this invention.

The computer 102 is coupled to a border router 1401 of the network 111, and a border router 1402 is coupled to the border router 104 of the network 112. Meanwhile, a border router 1411 of the network 110 is coupled to the border router 103 of the network 112, and a border router 1412 is coupled to the computer 101.

Streaming data is forwarded from the computer 101 to the computer 102, and QoS request specifications with delay of 400 milliseconds and jitter of 50 milliseconds are defined. If delay is 200 milliseconds and jitter is 200 milliseconds as a result of the measurement performed by computer 102, the delay satisfies the request specification, but jitter does not satisfy the request specification.

In a case where the jitter at an entrance to the jitter buffer endures up to 150 milliseconds if the jitter buffer of 100 milliseconds is added, the computer 102 transmits an REP message 461A with 150 milliseconds specified as the jitter value. The same format as the REP message 461 shown in FIG. 2D may be used for the REP message 461A with 150 milliseconds specified as the jitter value in the expected QoS value (QoS Expected) 274. Since the measurement value of jitter is 200 milliseconds, jitter may be reduced by 50 milliseconds in the network.

The border router 1401 receives the REP message 461A, and reports the received contents of the REP message 461A to a resource management server 1404 of the network 111. In a similar manner, the border router 1402 receives the REP message 461A, and reports the received contents of the REP message 461A to the resource management server 1404 of the network 111.

The resource management server 1404 distributes updated policies to the border router 1402 and a core router 1403. The policies are obtained by adjusting the bands and the weights of the WFQs so as to reduce jitter by 50 milliseconds. The border router 1402 transmits to the border router 104 an REP message 461B including content for increasing the jitter value of the expected QoS value (QoS Expected) 274 by 50 milliseconds.

It should be noted that the REP message 461 shown in FIG. 4C is forwarded by being divided into the REP message 461A between the computer 102 and the border router 1402 and the REP message 461B between the border router 1402 and the border router 104.

Upon reception of the REP message 461B, the border router 104 forwards the received REP message 461B as the REP message 462, and further reports the contents of the received REP message 461B to the resource management server 108. The policies with the bands and the weights of the WFQs adjusted so as to reduce jitter by 50 milliseconds are distributed from the resource management server 108 to the border router 103 and the core routers 106 and 107. However, the policies for the core routers 106 and 107 need not be distributed every time the REP message reaches, and may be distributed once every several times as necessary. This can reduce the overhead of the core routers 106 and 107.

Further, the border router 103 transmits to the border router 104 an REP message 465A including content for increasing jitter value of the expected QoS value (QoS Expected) 274 of the REP message 462 by 50 milliseconds. The REP message 465A is also transmitted to the network 110.

Upon reception of the REP message 465A, the border router 1411 reports the contents of the received REP message 465A to a resource management server 1414 of the network 110. In addition, the contents of the received REP message 465A is reported also from the border router 1412 to the resource management server 1414. The resource management server 1414 distributes updated policies to the border router 1412 and a core router 1413. The policies are obtained by adjusting the bands and/or the weights of the WFQs so as to reduce jitter by 50 milliseconds.

Further, the border router 1412 transmits the received REP message 465A as an REP message 465B to the computer 101. The REP message 465B includes content for increasing jitter value of the expected QoS value (QoS Expected) 274 by 50 milliseconds.

It should be noted that the REP message 465 shown in FIG. 4C is forwarded by being divided into the REP message 465A between the border router 103 and the border router 1412 and the REP message 465B between the border router 1412 and the computer 101.

The jitter value of the expected QoS value (QoS Expected) 274 of the REP message 465B that has reached the computer 101 is 300 milliseconds, which is larger than the measured jitter value 200 milliseconds. In other words, a QoS improvement with an excess of 100 milliseconds is made, which is disadvantageous in cost. Therefore, the computer 101 describes a jitter value in the expected QoS value (QoS Expected) 274 of the RREP message 471 being the response to the REP message 465, and notifies the border router 103 thereof.

Each of the networks attempts to reduce jitter value by 50 milliseconds by receiving the RREP message 471 and the RREP message 472 having the same contents as the RREP message 471. However, a width by which jitters are reduced may be 200/300 (⅔). In other words, each jitter may be reduced by approximately 17 milliseconds.

Therefore, the policy for each border router is changed, or a new policy is received through a communication with each resource management server. Alternatively, the policy is not updated by the DEC messages 468, 469, or 470, and only a tentative decision is conveyed to each router. It should be noted that a policy may be distributed by a new DEC message after receiving a notification from each border router followed by the reception of the RREP message.

As described above, according to the second embodiment, when there occurs a problem with QoS, first, the application (in particular, the receiving-end application) can be caused to participate in solution of the problem with QoS, and second, the solution can be shared among the plurality of network devices and/or the plurality of networks on the communication path. Accordingly, it is possible to effectively realize higher QoS at lower cost.

### Third Embodiment

In the above-mentioned first embodiment, the policy is set via the resource management server. However, the first embodiment may be modified as follows. In other words, in the sequence of FIG. 4C, each router can receive QoS improvement targets related to the own router as the SNSLP message, and can therefore perform the settings by itself without using the resource management server. This arrangement produces an effect that the messages can be prevented from being concentrated on the resource management server to become bottle neck.

Next, description will be made of a third embodiment of this invention.

In the third embodiment, instead of the above-mentioned sequence shown in FIG. 4C, a sequence shown in FIG. 4D is used as a sequence followed at the measurement result transmission time (in other words, at the feedback phase). In addition, in the third embodiment, as in the communication from the computer 101 to the computer 102 according to the first embodiment, voice data is transmitted from the computer 121 to the computer 122 by using a G.711 CODEC.

Traffic generated on the computer 121 passes through the access network 130, and enters the carrier's core network 112 from the border router 103. The traffic that has entered the network 112 passes through the core routers 106 and 107, is output from the border router 104 to leave the network 112, and passes through the access network 131 to reach the computer 122. The computers 121 and 122 have the same structures as the computers 101 and 102.

The communication sequence between the computer 121 and the computer 122 in the resource request phase is obtained by replacing the computer 101 and the computer 102 with the computer 121 and the computer 122, respectively, in FIG. 4A and the description thereof. In addition, the communication sequence between the computer 121 and the computer 122 in the resource release phase is obtained by replacing the computer 101 and the computer 102 with the computer 121 and the computer 122, respectively, in FIG. 4B and the description thereof.

Hereinafter, FIG. 4D will be used to describe a sequence followed in the feedback phase.

In the sequence shown in FIG. 4C, the settings of the router at the feedback time are changed by the resource management server 108 (in the second embodiment, also by the resource management servers 1404 and 1414). However, in a case where the states of networks frequently change, the settings need to be changed frequently, which increases the load on the resource management server. Therefore, in the third embodiment, each router is configured to execute a change, and a signaling performed only within a core network is introduced in order to reduce the load on the core router.

In FIG. 4D, first, there occurs a signaling within a core network. In other words, first, an REP message 481 is transmitted from the border router 104. The message is not transmitted on a flow basis as in the sequence shown in FIG. 4C, but transmitted on a class basis. In other words, in a case where there is a problem with QoS of a class corresponding to specific DSCP, one REP message is generated. The problem with QoS is detected when the statistical information (information including a packet discard amount within a queue and a queue length) related to the output queue measured by the border router 104 or the REP message received from the computer 102 or the like by the border router 104 before the reception of the REP message 481 deviates from a normal range.

In order to solve the detected problem with QoS, the border router 104 estimates a range (amount of (difference in) delay, jitter, or the like) improved by a QoS improvement made by the border router 104, describes the estimated delay amount or the like in the expected QoS value (QoS Expected) 274 of the REP message 481, and transmits the REP message 481 to the core router 107.

The core router 107 estimates the range (amount of (difference in) delay, jitter, or the like) improved by a QoS improvement made by the core router 107, describes in the REP message 482 a value obtained by adding the estimated delay amount or the like to the value described in each field of the expected QoS value (QoS Expected) 274 of the REP message 481, and transmits the REP message 482 to the border router 103.

The core router 106 estimates the range (amount of (difference in) delay, jitter, or the like) improved by a QoS improvement made by the core router 106, describes in the REP message 483 a value obtained by adding the estimated delay amount or the like to the value described in each field of the expected QoS value (QoS Expected) 274 of the REP message 482, and transmits the REP message 483 to the core router 106.

The amounts of the delay, the jitter, and the like improved by a QoS improvement made by each router are estimated as follows.

A traffic generator for generating traffic similar to the Internet traffic (for example, traffic generator conformed to the Markov-Modulated Poisson Process (MMPP) model) previously generates various kinds of traffic such as conversational voice, conversational video, streaming video, Web, FTP, and control traffic (SIP and RTCP) at various ratios, and measures mean values of the delay, the jitter, and the packet loss ratio under various conditions. Among those states that have been previously measured, a measurement value obtained in a state that is approximate to the state at the estimation time and satisfies the requested delay, jitter, and packet loss ratio may be set as an estimated value.

Further, the estimated value may be obtained by interpolating between measurement values obtained in some states approximate to the state at the estimation time. An approximation (in distance) between the state at the estimation time and the previously-measured state can be decided by comprehensively judging the approximation between numerical values of the delay, the jitter, the packet loss ratio, and the like for the traffic on a QoS class basis. For example, a distance is obtained for each of the delay, the jitter, the packet loss ratio, and the like, and the approximation is decided as a distance between vectors having those as their elements.

The border router 103 estimates how excessive the QoS improvement made by each router is based on the value of the expected QoS value (QoS Expected) 274 of the received REP message 483, describes an estimation result in the RREP message 484, and returns the RREP message 484. Each router within the core network makes an actual QoS improvement in terms of QoS based on the contents of the RREP message 484 and the RREP messages 485 and 486 being the messages obtained by forwarding the RREP message 484.

How excessive the QoS improvement is depends on the contents of the REP message and the RREP message which are exchanged between endpoint nodes. The state varies between flows, and hence the border router 103 averages a flow-basis state, and judges whether or not the QoS improvement is excessive. Messages (REP messages 491, 492, and 493, RREP messages 497, 498, and 499, and the like) that are exchanged between the endpoint nodes reach after the judgment, and hence there is a possibility of inconsistency with the judgment result. In that case, the policy is updated by the signaling within the core network again.

As described above, according to the third embodiment, when there occurs a problem with QoS, in addition to the effects of the first and second embodiments, it is possible to effectively prevent the load from concentrating on the resource management server. In addition, the core router does not need to process the messages on a flow basis, which makes it possible to effectively realize scalable QoS guarantee.

### Fourth Embodiment

Next, description will be made of a fourth embodiment of this invention.

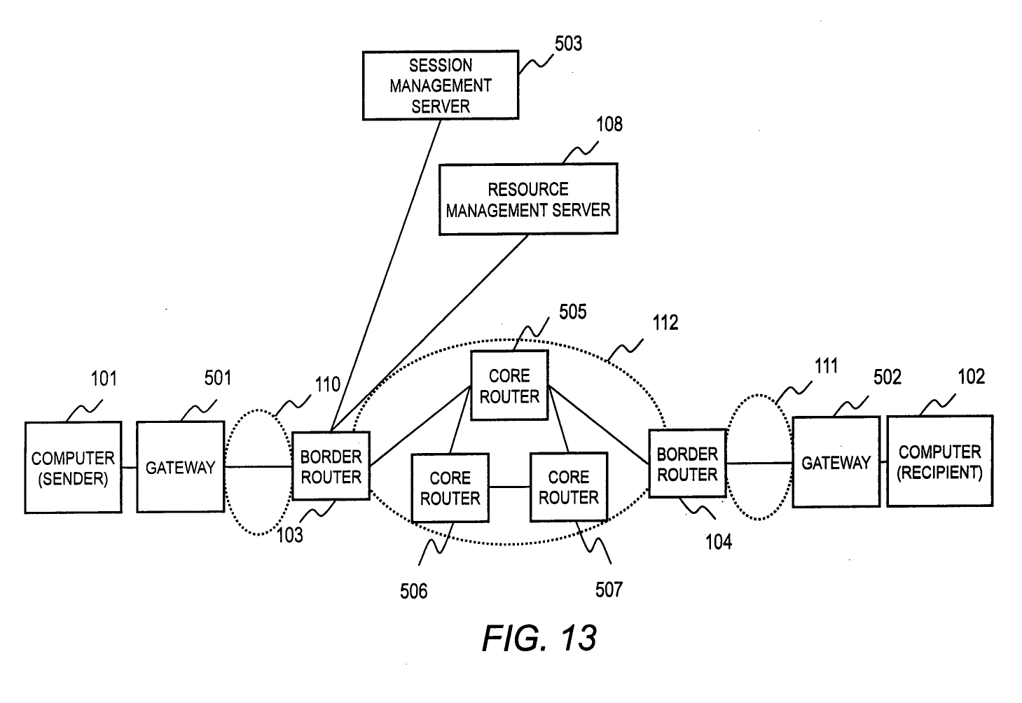

FIG. 13 is a block diagram showing a structure of a network system according to the fourth embodiment of this invention.

In the fourth embodiment, voice or images are transmitted from the computer 101 to the computer 102. Traffic generated on the computer 101 passes through a home gateway 501 and the network 110, and enters the carrier's core network 112 from the border router 103. The network 112 includes the border routers 103 and 104 and core routers 505, 506, and 507.

The traffic that has entered the network 112 passes through the core router 505, is output from the border router 104 to leave the network 112, and passes through the network 111 and a home gateway 502 to reach the computer 102. The QoS of the network 112 is managed by the resource management server 108.

Unlike the computers of the first to third embodiments described above, the computers 101 and 102 of the fourth embodiment have no function for the signaling via SNSLP. In the fourth embodiment, instead of performing the end-to-end signaling via SNSLP, the gateways 501 and 502 reference messages sent from the computers 101 and 102 and rewrite the contents of messages transmitted at the start and the end of a session using SIP, to thereby convey the QoS request specifications to the resource management server 108. Further, the QoS measurement result from the measurement performed by the gateway 502 is fed back to the network through a session management server 503 by communications between the gateways. If there is no cause of deterioration of QoS between the computer 101 and the gateway 501 and between the computer 102 and the gateway 502, this method can substantially guarantee the end-to-end QoS even between endpoint nodes having no QoS measurement function.

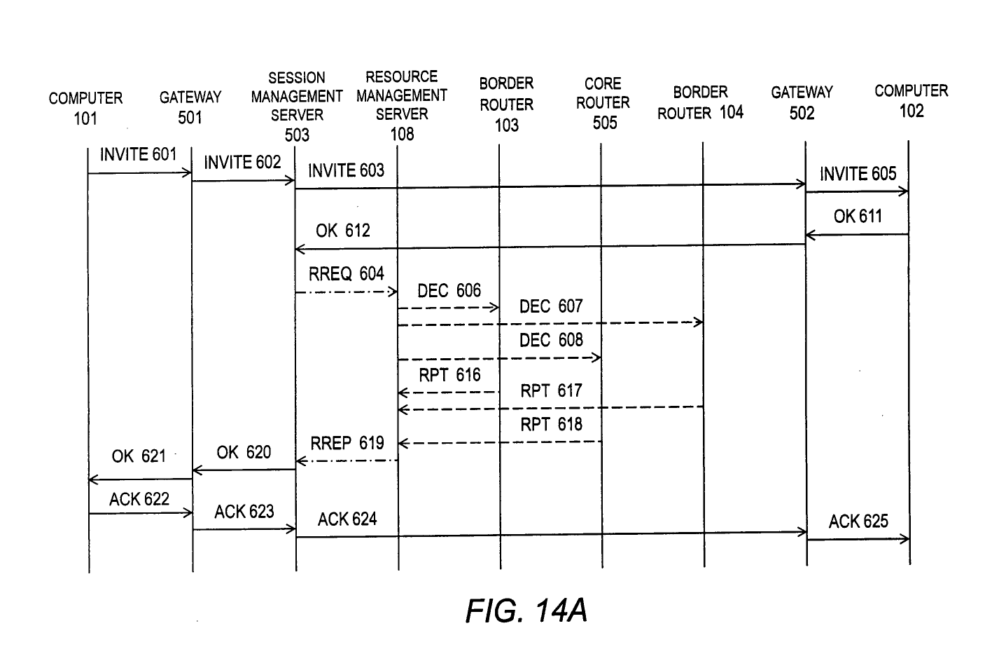

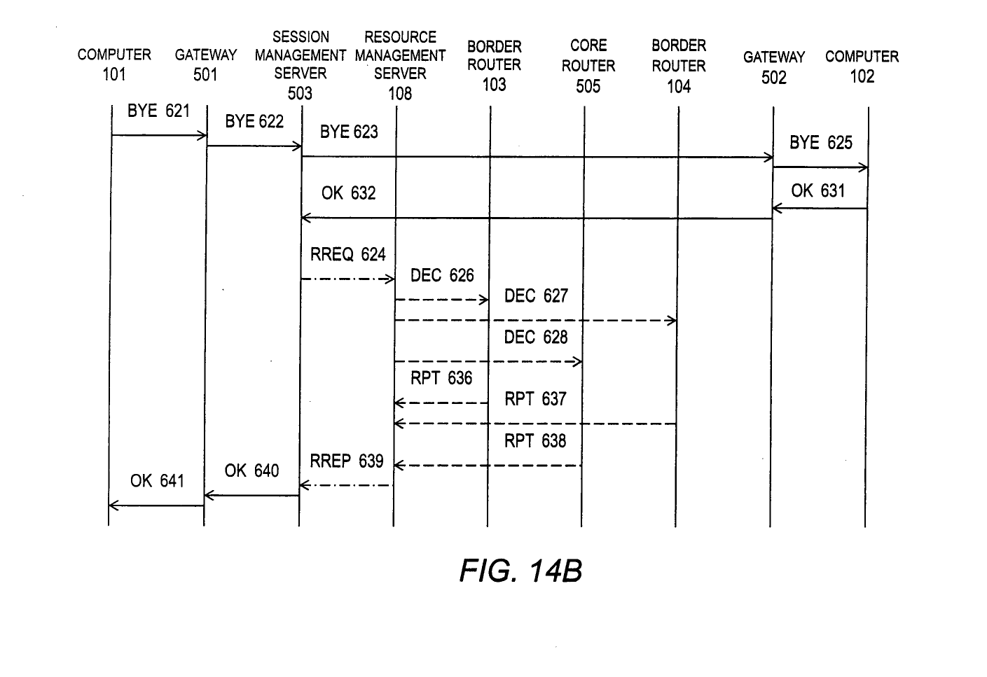

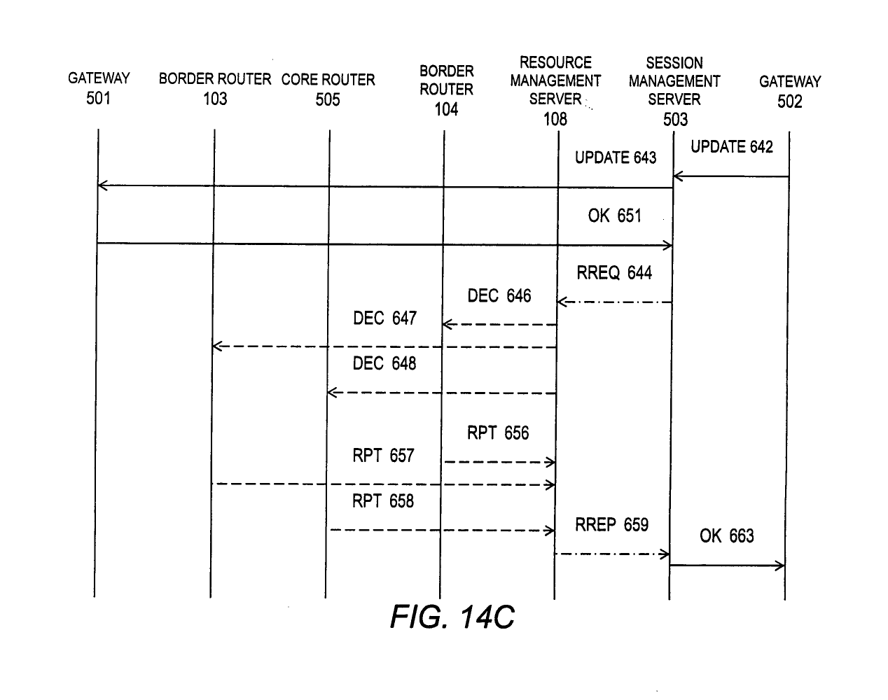

FIGS. 14A to 14C each show a communication sequence according to the fourth embodiment of this invention.

(Resource Request Phase)

FIG. 14A shows a sequence followed at the resource request time according to the fourth embodiment of this invention.

The computer 101 transmits an INVITE message 601 of SIP to the computer 102 (by specifying a URI of the computer 102 as the recipient). Here, Session Initiation Protocol (SIP) is an IETF-standard protocol provided for controlling the start and the end of a communication session. The INVITE message 601 includes a Session Description Protocol (SDP) message, and the SDP message includes the following media specification.

m=audio 8000 RTP/AVP 98

a=rtpmap:98 PCMU/8000/1

m=audio 8002 RTP/AVP 98

a=rtpmap:98 PCMU/8000/2

a=recvonly

The SDP message means that a two-way one-channel communication according to a CODEC called G.711 is performed in a UDP port 8000, while a one-way (only reception-purpose) two-channel communication according to the G.711 CODEC is performed in a port 8002. Therefore, the session management server 503 learns that upon reception of an INVITE message 602, in a case of using Ethernet for a communication via RTP, the port 8000 is used to perform a two-way communication with a bandwidth of 80 kbps, and the port 8002 is used to perform a one-way (only reception-purpose) communication with a bandwidth of 140 kbps.

The INVITE message 602 is captured by the gateway 502. The following lines are added to the INVITE message 602 for the first 2 lines of the media specification included in the INVITE message 602.

a=y1541-qos-class:0

a=path-latency: 100000

a=path-loss-ratio: 1000

a=jitter:50000

The first line indicates the specification of the QoS class of Y.1541, and the conversational class is specified. The second line indicates the specification of the delay, and a unit thereof is microsecond. Therefore, the above-mentioned specification represents 100 milliseconds. The third line indicates the specification of the packet loss ratio, and a unit thereof is 0.00000001. Therefore, the above-mentioned specification represents 0.001. The fourth line indicates the specification of the jitter, and a unit thereof is microsecond. Therefore, the above-mentioned specification represents 50 milliseconds. The specification is not standardized by IETF.

Further, the following lines are added to the INVITE message 602 for the last 3 lines of the media specification included in the INVITE message 602. After that, the INVITE message 602 is forwarded to the session management server 503.

a=y1541-qos-class:1

a=path-latency:400000

a=path-loss-ratio:1000

a=jitter:50000

The first line indicates the specification of the QoS class of Y.1541, and the streaming class is specified. The second line indicates the specification of the delay, and represents 400 milliseconds. The third line indicates the specification of the packet loss ratio, and represents 0.001. The fourth line indicates the specification of jitter, and represents 50 milliseconds.

As described above, the bandwidth can be acquired from the media specification, but may be specified explicitly by the following expressions.

a=bandwidth:AS 80000

and,

a=bandwidth:AS140000

The INVITE message 602 is captured by the session management server 503 of the network 112. The session management server 503 stores the contents of the INVITE message 602. Further, the INVITE message 602 is forwarded to the gateway 502 as the INVITE message 603 as it is. The forwarded INVITE message 603 reaches the gateway 502, and is rewritten into an INVITE message 605 having the same contents as the INVITE message 601 to be forwarded to the computer 102. This is because there is a possibility that the computer 102 may be processed incorrectly if the expressions related to QoS remain in the message.

Upon reception of the INVITE message 605, the computer 102 transmits a “200 OK” message 611 of SIP to the gateway 502 as a response to the computer 101 being the sender of the INVITE message 605 (by specifying a URI of the computer 101 as the recipient).

The gateway 502 adds the QoS request specifications to the “200 OK” message 611 to create a “200 OK” message 612. The QoS request specifications are the same as the QoS request specifications of the INVITE message 605. In other words, the QoS request specifications are the contents of the QoS request specifications of the INVITE message 605 stored in the gateway 502. The “200 OK” message 612 is forwarded to the session management server 503.

The session management server 503 stores the contents of the “200 OK” message 612 in association with the INVITE message 602. The session management server 503 references the stored contents of requests for: the IP address and the port identifier of the computer 101 in terms of the RTP communication; the bandwidth (80 kbps for the port 8000 and 140 kbps for the port 8002); the QoS class; the delay; the packet discard rate; and the jitter, which are contained in the INVITE message 603, copies those pieces of referenced information to an RREQ message 604, and further copies the IP address and the port identifier of the computer 102 in terms of the RTP communications, which are contained in the “200 OK” message 612, to the RREQ message 604. Then, the session management server 503 transmits the RREQ message 604 to the resource management server 108.

For brevity, FIG. 14A shows only one RREQ message 604, but the RREQ message is generated for each transmission port and each reception port. Herein, only the port 8000 is used for the transmission from the computer 101, while the port 8000 and the port 8002 are used for the reception of data to reach the computer 101. Accordingly, three messages are generated. The following DEC, OK, and RPT messages are also generated separately for each RREQ message.

Upon reception of the RREQ message 604, the resource management server 108 uses the internal database to determine the entrance border router 103 related to the flow concerned. Then, a policy for the determined entrance border router 103 is decided, and the decided policy is transmitted to the entrance border router 103 as a DEC message 606.

In a case where the resource management server 108 decides the policy for the entrance border router 103, the processing shown in FIG. 5 may be used in a similar manner to the resource request time. Further, FIG. 5 will be used to describe later the contents of the DEC message 606 transmitted to the entrance border router 103.

Further, if there is a need to change the policy for the core router 505, a DEC message 608 for changing the policy is transmitted to the core router 505. In addition, if there is a need to distribute a policy to the exit border router 104, the policy is transmitted to the border router 104 as a DEC message 607.

Upon completion of the policy settings based on the DEC message 606, the border router 103 transmits an RPT message 616 to the resource management server 108 as a response thereto. Also in a case where the border router 104 receives the DEC message 607, upon completion of the policy settings based on the received DEC message 607, the border router 104 transmits an RPT message 617 to the resource management server 108 as a response thereto.

Upon completion of the policy settings based on the DEC message 608, the core router 505 also transmits an RPT message 618 to the resource management server 108 as a response thereto. Upon completion of all of the policy settings (in other words, upon reception of all of the RPT messages 616, 617, and 618 that relate to all of the ports contained in the SDP message included in the INVITE message 602), the resource management server 108 transmits an RREP message 619 to the session management server 503 as a response to the RREQ message 604.

If the “200 OK” message 612 has already been received, upon reception of the RREP message 619, the session management server 503 forwards the “200 OK” message 612 to the gateway 501 as a “200 OK” message 620 as it is. If the “200 OK” message 612 has not been received yet, upon reception of the “200 OK” message 612, the session management server 503 transmits the “200 OK” message 620 to the gateway 501.

The gateway 501 eliminates the QoS request specifications from the “200 OK” message 620, and forwards the resultant to the computer 101 as a “200 OK” message 621. This is because there is a fear that the computer 102 may be processed incorrectly if the expressions related to QoS remain in the message.

The computer 101 transmits an ACK message 622 to the computer 102 as a response to the “200 OK” message 621. The ACK message 622 passes through the gateway 501, the session management server 503, and the gateway 502 to reach the computer 102 while maintaining the original format.

In the fourth embodiment, in a similar manner to the first embodiment, the resource management server 108 can determine the QoS request specifications, and hence it is possible to distribute a policy to each router as in the first embodiment.

In the fourth embodiment, the computers 101 and 102 each have an SIP message transmission/reception function containing a QoS request, but the computers 101 and 102 can be configured to communicate a QoS request with the gateway 501 and with the gateway 502, respectively, by using another protocol, and to allow the gateway 501 and the gateway 502, respectively, to convert the received QoS request into SIP.

Alternatively, the gateway 501 and the gateway 502 can be configured to receive an SIP message containing no QoS request from the computers 101 and 102, respectively, estimate a necessary QoS request from the SDP message including the media specification, and add the estimated QoS request to the SIP message.

In that case, for example, if the SDP message includes the two-way communication using G.711, the communication related to the SDP message is estimated as a communication of the conversational class, and hence it is estimated according to ITU-T Recommendation Y.1541 that the QoS class of the communication is “0”, the request value for delay is 100 milliseconds, the request value for the packet loss is 0.001, and the request value for jitter is 50 milliseconds. Alternatively, if the one-way communication using G.711 is included, the communication related to the SDP message is estimated as the communication of the streaming class, and hence it is estimated according to ITU-T Recommendation Y.1541 that the QoS class of the communication is “1”, the request value for delay is 400 milliseconds, the request value for the packet loss is 0.001, and the request value for jitter is 50 milliseconds.

(Resource Release Phase)

FIG. 14B shows a sequence followed at the resource release time according to the fourth embodiment of this invention.

The computer 101 transmits a BYE message 621 of SIP to the computer 102 (by specifying the URI of the computer 102 as the recipient). The BYE message 621 is forwarded to the session management server 503 by the gateway 501 as a BYE message 622 as it is. The BYE message 622 is forwarded to the gateway 502 as a BYE message 623 as it is. Further, the BYE message 623 is forwarded to the computer 102 as a BYE message 625 as it is.

Upon reception of the BYE message 625, the computer 102 transmits a “200 OK” message 631 of SIP to the gateway 502 as a response to the computer 101 being the sender of the BYE message 625 (by specifying the URI of the computer 101 as the recipient). The gateway 502 forwards the “200 OK” message 631 to the session management server 503 as a “200 OK” message 632 as it is.

Based on the URIs of the recipient and the sender and the information stored in the BYE message 622, the session management server 503 copies the IP address and the port identifier of the computer 101 in terms of the RTP communication, which are contained in the INVITE message 603, to an RREQ message 624, and further copies the IP address and the port identifier of the computer 102 in terms of the RTP communication, which are contained in the “200 OK” message 632, to the RREQ message 624. Then, the session management server 503 transmits the RREQ message 624 to the resource management server 108.

For brevity, FIG. 14B shows only one RREQ message 624, but the RREQ message is generated for each transmission port and each reception port. Herein, only the port 8000 is used for the transmission from the computer 101, while the port 8000 and the port 8002 are used for the reception of data to reach the computer 101. Accordingly, three messages are generated. The following DEC, OK, and RPT messages are also generated separately for each RREQ message.

Upon reception of the RREQ message 624, the resource management server 108 uses the internal database to determine the entrance border router 103 related to the flow concerned. Then, a policy for the determined entrance border router 103 is decided, and the decided policy is transmitted to the entrance border router 103 as a DEC message 626. The border router 103 cancels the distributed policy, and releases the resource.

Further, if there is a need to change the policy for the core router 505, a DEC message 628 for changing the policy is transmitted to the core router 505. In addition, if there is a need to change the policy for the exit border router 104, a new policy is transmitted to the border router 104 as a DEC message 627.

Upon completion of the policy cancellation based on the DEC message 626, the border router 103 transmits an RPT message 636 to the resource management server 108 as a response thereto. Also in a case where the border router 104 receives the DEC message 627, upon completion of the policy cancellation based on the received DEC message 627, the border router 104 transmits an RPT message 637 to the resource management server 108 as a response thereto.

Upon completion of the policy cancellation based on the DEC message 628, the core router 505 also transmits an RPT message 638 to the resource management server 108 as a response thereto. Upon completion of all of the policy cancellation (in other words, upon reception of all of the RPT messages 636, 637, and 638 that relate to all of the ports contained in the SDP message included in the BYE message 622), the resource management server 108 transmits an RREP message 639 to the session management server 503 as a response to the RREQ message 624.

If the “200 OK” message 632 has already been received, upon reception of the RREP message 639, the session management server 503 forwards the “200 OK” message 632 to the gateway 501 as a “200 OK” message 640 as it is. If the “200 OK” message 632 has not been received yet, upon reception of the “200 OK” message 632, the session management server 503 transmits the “200 OK” message 640 to the gateway 501.

The gateway 501 forwards the “200 OK” message 640 to the computer 101 as a “200 OK” message 641 as it is.

In the fourth embodiment, in a similar manner to the first embodiment, the resource management server 108 can determine the QoS request specifications, and hence it is possible to change the policy for each router based on the feedback as in the first embodiment.

Further, by inserting the QoS measurement result into the SDP message, it becomes possible to feed back the QoS measurement result without addition of a new protocol, producing an effect that the development man-hours can be reduced. Further, the QoS measurement result does not change the contents of the existing SDP message such as the media specification, and is therefore ignored by a SIP proxy and agent requiring no QoS measurement result. Accordingly, there is no need to revise programs thereof, producing an effect that the development man-hours can be reduced.

(Feedback Phase)

FIG. 14C shows a sequence followed at the measurement request transmission time (in other words, at the feedback time) according to the fourth embodiment of this invention.

In the fourth embodiment, the gateway 502 measures the delay, the jitters, and the packet discard rate. In other words, each time an RTP packet passes, the gateway 502 obtains the delay and the jitters from the timestamp contained in the RTP packet and the SR packet of RTCP. Further, the gateway 502 records the sequence number to obtain the packet discard rate. A method used therefor is the same as the method used by the computer 102 in the first embodiment. It should be noted that in a case where the computer 101 does not generate an SR packet, the gateway 501 may transmit the SR packet to the gateway 502.

The gateway 502 specifies the URI of the computer 102 and the URI of the computer 101 as the sender and the recipient, respectively, and transmits an UPDATE message 642 of SIP to the session management server 503.

The session management server 503 forwards the UPDATE message 642 to the gateway 501 as an UPDATE message 643 as it is. Upon reception of the UPDATE message 643, without forwarding the UPDATE message 643 to the computer 101, the gateway 501 transmits a “200 OK” message 651 of SIP to the session management server 503 by specifying the URI of the computer 101 as the recipient.

The UPDATE message 642 includes a Session Description Protocol (SDP) message, and the SDP message includes the following media specification and the QoS measurement result related to the media.

m=audio 8000 RTP/AVP 98

a=rtpmap:98 PCMU/8000/1

a=path-latency: 12345

a=jitter:54321

The first and second lines specify an RTP flow to be measured. If the INVITE message or the like contains the description of SDP, the description generally means a two-way communication. However, it is an object herein to convey the receiving-end measurement result, the description means only a reception flow. The third line indicates the measurement result of the delay, and a unit thereof is microsecond. Therefore, the above-mentioned measurement result represents 12.345 milliseconds. The fourth line indicates the measurement result of the jitter, and a unit thereof is microsecond. Therefore, the above-mentioned measurement result represents 54.321 milliseconds.

The UPDATE message originally has an object to specify communication conditions and media used for the communication and change specification thereof midway through the communication. Therefore, the feedback of the measurement result as described above is not taken into consideration. Accordingly, specification thereof is not standardized by IETF. However, the contents of the UPDATE message may be decided between a recipient thereof and a sender thereof, and can be used for the transmission/reception of the measurement result.

Based on the URIs of the recipient and the sender and the information stored in the UPDATE message 642, the session management server 503 copies the IP address and the port identifier of the computers 101 and 102 in terms of the RTP communication to an RREQ message 644. Then, the session management server 503 transmits the RREQ message 644 to the resource management server 108.

Upon reception of the RREQ message 644, the resource management server 108 uses the internal database to determine the entrance border router 103 related to the flow concerned. Then, as necessary, a policy for the determined entrance border router 103 is decided, and the decided policy is transmitted to the entrance border router 103 as a DEC message 647. The border router 103 changes the distributed policy.

Further, if there is a need to change the policy for the core router 505, a DEC message 648 for changing the policy is transmitted to the core router 505. In addition, if there is a need to change the policy for the exit border router 104, a new policy is transmitted to the border router 104 as a DEC message 646.

Upon completion of the policy change based on the DEC message 647, the border router 103 transmits an RPT message 657 to the resource management server 108 as a response thereto. Also in a case where the border router 104 receives the DEC message 646, upon completion of the policy change based on the received DEC message 646, the border router 104 transmits an RPT message 657 to the resource management server 108 as a response thereto.

Upon completion of the policy change based on the message 648, the core router 505 also transmits an RPT message 658 to the resource management server 108 as a response thereto. Upon completion of all of the policy changes (in other words, upon reception of all of the RPT messages 656, 657, and 658), the resource management server 108 transmits an RREP message 659 to the session management server 503 as a response to the RREQ message 644.

If the “200 OK” message 651 has already been received, upon reception of the RREP message 659, the session management server 503 forwards the “200 OK” message 651 to the gateway 502 as a “200 OK” message 663 as it is. If the “200 OK” message 651 has not been received yet, upon reception of the “200 OK” message 651, the session management server 503 transmits the “200 OK” message 663 to the gateway 502. The gateway 502 does not forward the “200 OK” message 663 to the computer 102.

Further, in the fourth embodiment, the computers 101 and 102 have the function of transmitting the RTCP message. However, if the computers 101 and 102 have no function of transmitting the RTCP message, the gateways 501 and 502 may substitute the computers 101 and 102, respectively, to perform the function of transmitting the RTCP message.

In other words, the gateways 501 and 502 can monitor an RTP packet sent out from the computers 101 and 102, respectively, and generate an SR packet and another RTCP message based on the contents of the RTP packet. The timestamp contained in the SR message may be a time at which the gateway 501 receives the RTP packet concerned from the computer 101, which is described according to the internal clock of the gateway 501.

In the fourth embodiment, in a similar manner to the first embodiment, the resource management server 108 can determine the QoS request specifications, and hence it is possible to change a policy for each router as in the first embodiment.

Further, by inserting the QoS measurement result into the SDP message, it becomes possible to feed back the QoS measurement result without addition of a new protocol, producing an effect that the development man-hours can be reduced. Further, the QoS measurement result does not change the contents of the existing SDP message such as the media specification, and is therefore ignored by a SIP proxy and agent requiring no QoS measurement result. Accordingly, there is no need to revise programs thereof, producing an effect that the development man-hours can be reduced.

While the present invention has been described in detail and pictorially in the accompanying drawings, the present invention is not limited to such detail but covers various obvious modifications and equivalent arrangements, which fall within the purview of the appended claims.

What is claimed is:

1. A network system, which is coupled to a first computer having a communication interface and a second computer having a communication interface, comprising:
at least one network node provided on a communication path between the first computer and the second computer, for forwarding a packet between the first computer and the second computer;
a network device for forwarding control information transmitted from the second computer to the first computer, and capturing the control information; and
a resource management server for controlling the network node, wherein:
QoS requirements are set for a communication between the first computer and the second computer;
the first computer periodically transmits a packet to the second computer to perform a first communication;
the second computer measures QoS of the first communication, and transmits the control information including an identifier of the first communication and a result of the measurement of QoS to the first computer via the network device;
the network device captures the control information, and transmits to the resource management server a message including the identifier of the first communication and the measurement result which are extracted from the captured control information; and
the resource management server estimates a cause of failure in satisfying the QoS requirements if the measurement result does not satisfy the QoS requirements, and sets QoS for the network node judged to involve the cause.

2. The network system according to claim 1, wherein:
at least one network node includes a first network node for placing a limitation on communication traffic of the communication using the forwarded packet; and
in a case where the first network node is set to place the limitation on the communication traffic of the first communication according to the QoS requirements set for the first communication, if the measurement result does not satisfy the QoS requirements, the resource management server estimates that the first network node is the cause of failure in satisfying the QoS requirements, and sets the QoS in the first network node so as to relax the limitation placed on the communication traffic of the first communication.

3. The network system according to claim 1, wherein:
at least one network node includes a second network node for classifying input packets into a plurality of classes, and outputting the classified packets according to output bandwidths allocated to the plurality of classes; and
in a case where the second network node classifies the first communication as a particular class according to the QoS requirements set for the first communication, if the measurement result does not satisfy the QoS requirements, the resource management server estimates that the second network node is the cause of failure in satisfying the QoS requirements, and sets the QoS so that the second network node increases the output band for the particular class.

4. The network system according to claim 1, wherein:
at least one network node includes a third network node for classifying input packets into a plurality of classes, and scheduling the classified packets according to priorities set for the plurality of classes; and
in a case where the third network node classifies the first communication as a particular class according to the QoS requirements set for the first communication, if the measurement result does not satisfy the QoS requirements, the resource management server estimates that the third network node is the cause of failure in satisfying the QoS requirements, and sets the QoS so that the third network node increases the priority for the particular class.

5. The network system according to claim 1, wherein if the measurement result exceeds the set QoS requirements, the resource management server notifies the measurement result to the first computer via the network node.

6. The network system according to claim 1, wherein:
the network system forwards a packet of a second communication other than the packet of the communication between the first computer and the second computer; and
if the measurement result does not satisfy the QoS requirements set for the first communication but if the measurement result of the QoS of the second communication satisfies the QoS requirements, the resource management server sets the QoS so that the network node places the limitation on the communication traffic of the second communication.

7. The network system according to claim 1, further comprising an expansion device for expanding a function of the network node, wherein:
at a time of starting a communication session with respect to the second computer, the first computer transmits a resource request message including a request for a resource to be used for the communication session to the second computer via the network node;
if the second computer receives the resource request message, the network node forwards the received resource request message to the expansion device; and
the expansion device forwards the forwarded resource request message to the network node, and sets the QoS for the network node according to the resource request included in the forwarded resource request message.

8. The network system according to claim 1, further comprising an expansion device for expanding a function of the network node, wherein:
the first computer transmits statistical information related to a communication with the second computer during the communication with the second computer;
if the network node receives the statistical information, the network node forwards the received statistical information to the expansion device; and
the expansion device forwards the forwarded statistical information to the network node, and if the forwarded statistical information does not satisfy the QoS requirements, the expansion device changes a setting on the QoS for the network node.

9. The network system according to claim 1, wherein:
the control information includes information on a portion whose QoS can be improved by the second computer; and
the resource management server sets QoS so that the network node improves the QoS of a portion obtained by subtracting the portion whose QoS can be improved by the second computer.

10. The network system according to claim 9, wherein:
the QoS requirements include requirements for jitter;
the measurement result includes a measurement value of jitter; and
the control information includes a value of jitter that can be absorbed by a buffer of the second computer as the information on the portion whose QoS can be improved by the second computer.

11. A network system, which is coupled to a first computer having a communication interface and a second computer having a communication interface, comprising:
a first network;
a first gateway provided on a communication path between the first computer and the first network; and
a second gateway provided on a communication path between the second computer and the first network,
the first network including:
at least one network node provided to a communication path between the first computer and the second computer, for forwarding a packet between the first computer and the second computer;
a network device for forwarding control information transmitted from the second computer to the first computer, and capturing the control information; and
a resource management server for controlling the network node, wherein:
QoS requirements are set for a communication between the first computer and the second computer;
the first computer periodically transmits a packet to the second computer to perform a first communication;
the second gateway measures QoS of the first communication to obtain a first measurement result, and transmits a piece of first control information including an identifier of the first communication and the first measurement result to the first gateway via the network device;
the network device captures the first control information, and transmits to the resource management server a message including the identifier of the first communication and the first measurement result which are extracted from the captured first control information; and
the resource management server estimates a cause of failure in satisfying the QoS requirements if the first measurement result does not satisfy the QoS requirements, and sets QoS for the network node judged to involve the cause.

12. The network system according to claim 11, wherein:
the second computer transmits a piece of second control information to the first computer via the network device;
the second gateway measures QoS of the first communication and adds the measurement result to the second control information;
the network device captures the second control information, and transmits to the resource management server a message including the identifier of the first communication and the second measurement result which are extracted from the captured second control information; and
the resource management server estimates the cause of failure in satisfying the QoS requirements if the second measurement result does not satisfy the QoS requirements, and sets QoS for the network node judged to involve the cause.

13. A network system, which is coupled to a first computer having a communication interface and a second computer having a communication interface, comprising a fourth network node and a fifth network node which are provided on a communication path between the first computer and the second computer, for forwarding a packet between the first computer and the second computer, wherein:
QoS requirements are set for a communication between the first computer and the second computer;
the first computer periodically transmits a packet to the second computer to perform a first communication;
the second computer measures QoS of the first communication, and transmits a piece of third control information including an identifier of the first communication, the measurement result of QoS, and information on a portion whose QoS can be improved by the second computer to the first computer via the fourth network node and the fifth network node;
when the third control information passes, the fifth network node adds information on a portion whose QoS can be improved between the second computer and the fifth network node, to the third control information; and
the fourth network node references the third control information to set QoS so that the first network node improves the QoS of another portion obtained by subtracting the portion whose QoS can be improved.

14. The network system according to claim 13, wherein:
the QoS requirements include requirements for jitter;
the third measurement result includes a measurement value of jitter; and
the third control information includes a value of jitter that can be absorbed by a buffer of the fifth network node as the information on the portion whose QoS can be improved between the second computer and the fifth network node.

15. A network system, which is coupled to a first computer having a communication interface and a second computer having a communication interface, comprising:
at least one network node provided on a communication path between the first computer and the second computer, for forwarding a packet;
a network device for forwarding control information transmitted from the second computer to the first computer, and capturing the control information;
a resource management server for controlling the network node; and
a measurement module for measuring QoS of a communication between the first computer and the second computer, wherein:
QoS requirements are set for a communication between the first computer and the second computer;
the first computer periodically transmits a packet to the second computer to perform a first communication;
the measurement module measures QoS of the first communication, and transmits the measurement result to the resource management server via the network device; and
the resource management server is configured to:
calculate QoS requirements to be newly set for the network node if the measurement result does not satisfy the QoS requirements; and
set QoS for the network node if a difference between the QoS requirement to be newly set and a current QoS requirement is outside a predetermined range.
